(19) United States
(12) Patent Application Publication
(10) Pub. No.: US 2023/0354860 A1
(43) Pub. Date: Nov. 9, 2023

(54) STARCH COMPOSITION FOR FOOD PRODUCTS AND METHOD FOR PRODUCING SAID STARCH COMPOSITION

(71) Applicant: J-OIL MILLS, Inc., Tokyo (JP)

(72) Inventors: Saika SATO, Tokyo (JP); Junpei KUBOTA, Tokyo (JP); Kai YAMAGATA, Tokyo (JP); Tomoki HORIGANE, Tokyo (JP); Mina YOSHIMURA, Tokyo (JP)

(21) Appl. No.: 18/245,168

(22) PCT Filed: Sep. 30, 2021
(86) PCT No.: PCT/JP2021/036130

§ 371 Date: Mar. 14, 2023

(30) Foreign Application Priority Data
Oct. 5, 2020 (JP) 2020-168214
Apr. 7, 2021 (JP) 2021-065143

(51) Int. Cl. A23L 29/219; A23G 9/34; A23L 3/36; A23D 7/005; A23L 5/10

(52) U.S. Cl. CPC A23L 29/219; A23D 7/0053; A23G 9/34; A23L 3/36; A23L 5/17

(57) ABSTRACT

The present invention provides a novel raw material that can improve the texture of food products and also can impart a new function to food products. The present invention relates to a starch composition for food products, the starch composition having a type-B viscometer viscosity (Pa·s) of 2-100 Pa·s, the viscosity being determined when a slurry that is obtained at 20° C., by mixing into the starch composition for food products an edible oil/fat in the amount of two times greater than the starch composition in terms of mass and water in the amount of seven times greater than the starch composition in terms of mass, in this order and without heating, is subjected to a viscosity measurement under the condition of 30 rpm for 30 seconds. The starch composition also has a type-B viscometer viscosity (Pa·s) that satisfies the condition of “the type-B viscometer viscosity at 0° C. is 2-30 times greater than the type-B viscometer viscosity at 90° C.” and that is determined when the slurry is cooled or heated and is subjected to viscosity measurement under the condition of 30 rpm for 30 seconds.

### TECHNICAL FIELD

The present invention relates to a starch composition for food products and a method for producing the same. The present invention also relates to an emulsified composition containing the starch composition for food products, to a food product such as a frozen dessert containing the starch composition for food products or the emulsified composition, and to an ice-crystal stabilizer and a method for stabilizing ice crystals using the starch composition for food products or the emulsified composition as an active ingredient.

### BACKGROUND ART

Modified starches are used to improve the textures and to impart new functions to a variety of processed food products, including bakery products, confections, frozen desserts, noodles, dairy products, and meat products. In recent years, expectations for modified starches in the food product industry have increased due to the diversification of textures demanded by consumers, and there are needs to provide novel ingredients that can impart various functions to food products in order to increase the product value.

For example, when a frozen food product such as a frozen dessert is placed under conditions where the storage temperature rises, for example, when the door of a commercial freezer or home refrigerator is opened and closed or during dry ice shipping, ice crystals in the frozen food product grow, causing the product to feel grainy and coarse upon eating, leading to poor mouthfeel.

Here, Patent literature 1 discloses a composite modified starch obtained by modifying a raw or modified starch under high pressure in the presence of a surfactant, and describes that it has excellent processing properties and aging resistance.

### CITATION LIST

### Patent Literature

Patent literature 1: Japanese Unexamined Patent Application Publication No. 2007-070580

### SUMMARY OF INVENTION

### Technical Problem

Under these circumstances, it is desirable to provide a novel ingredient that can improve the texture of food products or that can impart a new function to food products.

Especially for frozen food products such as frozen desserts, it is desirable for ice crystals to remain stable even when placed under unstable temperature conditions, for example, where the storage temperature rises.

### Solution to Problem

The present invention relates to a starch composition for food products, to a method for producing said starch composition, to an emulsified composition containing the starch composition for food products, to a food product containing the starch composition for food products or the emulsified composition, to an ice-crystal stabilizer, to a method for stabilizing ice crystals using the starch composition for food products or the emulsified composition as an active ingredient, and the like, shown below.

A starch composition for food products, wherein the Brookfield viscosity (Pa•s) of a slurry, which is obtained by mixing the starch composition for food products with an edible oil/fat that is twice as much and water that is 7 times as much as the mass of the starch composition for food products in this order at 20° C. without heating, measured under the conditions of 30 rpm for 30 seconds is not lower than 2 Pa•s and not higher than 100 Pa•s, and
wherein the Brookfield viscosity (Pa•s) of the slurry measured under the conditions of 30 rpm for 30 seconds after cooling or heating the slurry satisfies the following condition:
“the Brookfield viscosity at 0° C. is not less than twice and not more than 30 times the Brookfield viscosity at 90° C.”.

The starch composition for food products according to [1] above, wherein the Brookfield viscosity (Pa•s) of the slurry at 0° C. is not lower than 5 Pa•s and not higher than 300 Pa•s.

The starch composition for food products according to either one of [1] and [2] above, wherein the difference between the Brookfield viscosities (Pa•s) of the slurry at the temperatures of 20° C., 30° C., 40° C., 50° C. and 60° C. when a freeze-thaw cycle is repeated three times under the following conditions and the Brookfield viscosities (Pa•s) at the corresponding temperatures before the freeze-thaw cycle is within 10.0 Pa·s:
“<Conditions for freeze-thaw cycles>
for the first cycle, the slurry prepared at room temperature is cooled to -10° C. at a cooling rate of -1° C./min and kept in that state for at least 15 hours, then the slurry is heated to reach 60° C. at a heating rate of 45° C./min, and then cooled again to -10° C. at a cooling rate of -1° C./min and kept in that state for at least 15 hours; and
for the second cycle and on, the slurry that went through the first cycle is heated to reach 60° C. at a heating rate of 45° C./min and then cooled again to -10° C. at a cooling rate of -1° C./min and kept in that state for at least 15 hours.”

The starch composition for food products according to any one of [1] to [3] above, wherein the starch composition is obtained by subjecting a polyglycerol fatty acid ester and one or more selected from the group consisting of raw potato starch and modified starches of said raw potato starch to a heat treatment under a pressure condition of 0 MPa or higher but lower than 100 MPa, and the starch composition comprises a starch-lipid complex.

The starch composition for food products according to [4] above, wherein the mass ratio of the polyglycerol fatty acid ester to 100 parts by mass of the one or more raw material starches selected from the group consisting of raw potato starch and modified starches of said raw potato starch is not less than 0.01 and not more than 4.8 parts by mass.

A starch composition for food products obtained by subjecting a polyglycerol fatty acid ester and one or more selected from the group consisting of raw potato starch and modified starches of said raw potato starch to a heat treatment under a pressure condition of 0 MPa or higher but lower than 100 MPa, wherein the starch composition comprises a starch-lipid complex.

The starch composition for food products according to [6] above, wherein the mass ratio of the polyglycerol fatty acid ester to 100 parts by mass of the one or more raw material starches selected from the group consisting of raw potato starch and modified starches of said raw potato starch is not less than 0.01 and not more than 4.8 parts by mass.

The starch composition for food products according to either one of [6] and [7] above, wherein the modified starch of raw potato starch is a modified starch obtained by subjecting the raw potato starch to one or more modification treatments selected from the group consisting of cross-linking, hydroxypropylation, and esterification.

The starch composition for food products according to any one of [6] to [8] above, wherein the polyglycerol fatty acid ester has a HLB value of not lower than 1 and not higher than 13 and an average degree of polymerization of not less than 2 and not more than 9.

The starch composition for food products according to any one of [6] to [9] above, wherein the Brookfield viscosity (Pa•s) of a slurry, which is obtained by mixing the starch composition for food products with an edible oil/fat that is twice as much and water that is 7 times as much as the mass of the starch composition for food products in this order at 20° C. without heating, measured under the conditions of 30 rpm for 30 seconds is not lower than 2 Pa•s and not higher than 100 Pa•s, and
wherein the Brookfield viscosity (Pa•s) of the slurry measured under the conditions of 30 rpm for 30 seconds after cooling or heating the slurry satisfies the following condition:
“the Brookfield viscosity (Pa•s) at 0° C. is not less than twice and not more than 30 times the Brookfield viscosity at 90° C.”.

The starch composition for food products according to [10] above, wherein the Brookfield viscosity of the slurry at 0° C. is not lower than 5 Pa•s and not higher than 300 Pa•s.

The starch composition for food products according to either one of [10] and [11] above, wherein the difference between the Brookfield viscosities (Pa•s) of the slurry at the temperatures of 20° C., 30° C., 40° C., 50° C. and 60° C. when a freeze-thaw cycle is repeated three times under the following conditions and the Brookfield viscosities (Pa•s) at the corresponding temperatures before the freeze-thaw cycle is within 10.0 Pa·s:
“<Conditions for freeze-thaw cycles>
for the first cycle, the slurry prepared at room temperature is cooled to -10° C. at a cooling rate of -1° C./min and kept in that state for at least 15 hours, then the slurry is heated to reach 60° C. at a heating rate of 45° C./min, and then cooled again to -10° C. at a cooling rate of -1° C./min and kept in that state for at least 15 hours; and
for the second cycle and on, the slurry that went through the first cycle is heated to reach 60° C. at a heating rate of 45° C./min and then cooled again to -10° C. at a cooling rate of -1° C./min and kept in that state for at least 15 hours.”

A method for producing a starch composition for food products, the method comprising a step of subjecting an ingredient mixture containing a polyglycerol fatty acid ester and one or more selected from the group consisting of raw potato starch and modified starches of said raw potato starch to a heat treatment under a pressure condition of 0 MPa or higher but lower than 100 MPa.

The method for producing a starch composition for food products according to [13] above, wherein the mass ratio of the polyglycerol fatty acid ester to 100 parts by mass of the one or more raw material starches selected from the group consisting of raw potato starch and modified starches of said raw potato starch is not less than 0.01 and not more than 4.8 parts by mass.

The method for producing a starch composition for food products according to either one of [13] and [14] above, wherein the modified starch of raw potato starch is a modified starch obtained by subjecting the raw potato starch to one or more modification treatments selected from the group consisting of cross-linking, hydroxypropylation, and esterification.

The method for producing a starch composition for food products according to any one of [13] to [15] above, wherein the polyglycerol fatty acid ester has a HLB value of not lower than 1 and not higher than 13 and an average degree of polymerization of not less than 2 and not more than 9.

The method for producing a starch composition for food products according to any one of [13] to [16] above, wherein the step of heat treatment comprises performing a heat treatment by pressurizing and extruding the ingredient mixture using an extruder.

An emulsified composition comprising the starch composition for food products according to any one of [1] to [12] above, an edible oil/fat that is not less than 0.5 times and not more than 10 times the mass of the starch composition for food products, and water that is not less than 0.5 times and not more than 10 times the mass of the starch composition for food products.

A food product comprising the starch composition for food products according to any one of [1] to [12] above or the emulsified composition according to [18] above.

The food product according to [19] above, wherein the food product is a frozen dessert.

A method for imparting a thick texture to a frozen dessert, the method comprising blending the starch composition for food products according to any one of [1] to [12] above or the emulsified composition according to [18] above into the frozen dessert.

An ice-crystal stabilizer, comprising the food product comprising the starch composition for food products according to any one of [1] to [12] above or the emulsified composition according to [18] above as an active ingredient.

A method for stabilizing ice crystals in a frozen food product, the method comprising blending the starch composition for food products according to any one of [1] to [12] above or the emulsified composition according to [18] above into the frozen food product.

### ADVANTAGEOUS EFFECTS OF INVENTION

The starch composition for food products according to the present invention is highly oil- and water-absorbent and can have characteristic properties when mixed with an edible oil/fat and water. According to a preferred aspect of the present invention, the starch composition for food products can be blended into a food product together with an edible oil/fat and water or together with water to improve the texture of the food product or impart a new texture, such as pleasant meltability in mouth or a thick, smooth texture, to the food product.

The ice-crystal stabilizer according to the present invention can inhibit the growth of ice crystals in a frozen food product even when the food product is stored for long periods of time under freezing conditions where the storage temperature is unstable, for example, when the door of a commercial freezer or home freezer is opened and closed, or during dry ice shipping. More specifically, when the ice-crystal stabilizer of the present invention is applied to, for example, a frozen dessert, it is possible to maintain its smooth texture for a long period of time without causing grainy and coarse feeling under such storage conditions. Use of the ice-crystal stabilizer of the present invention for a frozen dessert can also prevent the frozen dessert from melting easily and provide excellent shape retention property even under unstable temperature conditions.

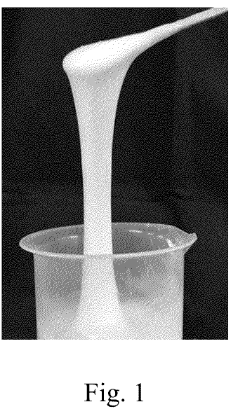

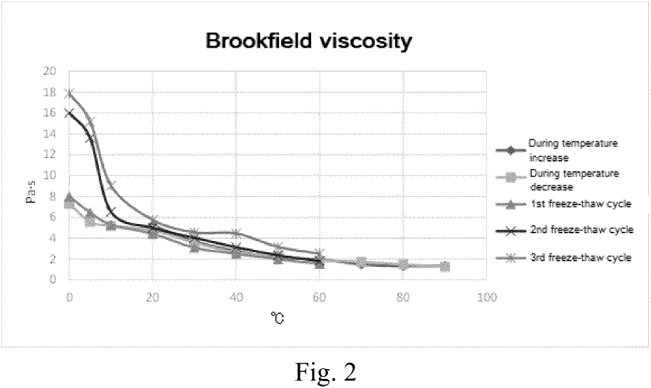

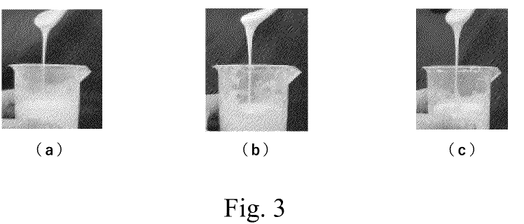

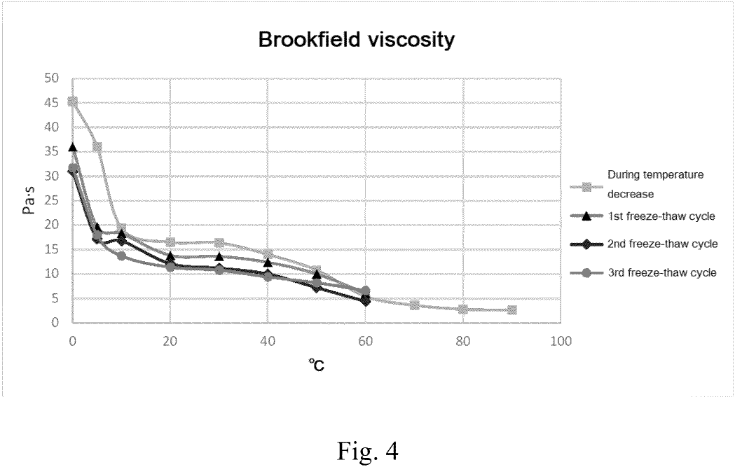

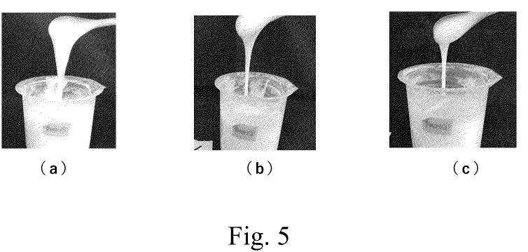

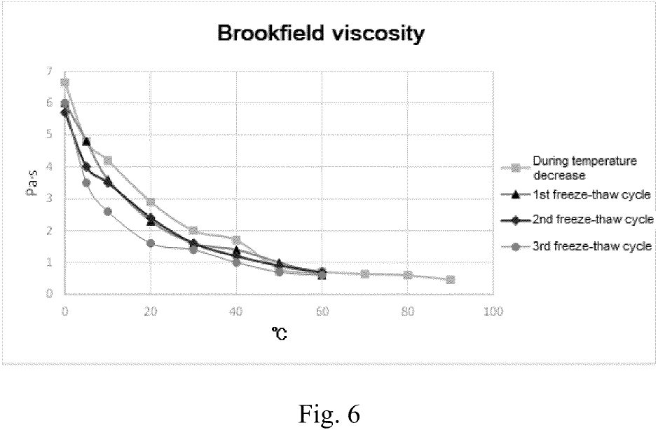

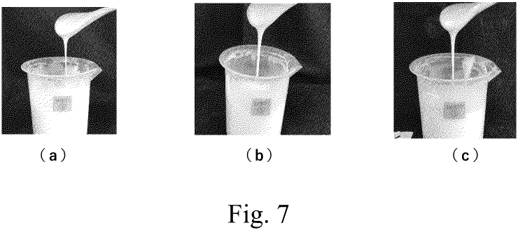

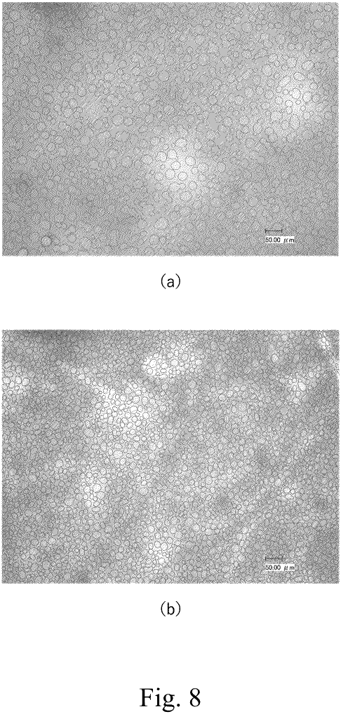

### BRIEF DESCRIPTION OF DRAWINGS

[FIG. 1] A photograph showing the property of a slurry containing the starch composition for food products of Example 1-2 (starch composition for food products: edible oil/fat: water = 1:2:7) in unheated state.

[FIG. 2] A graph showing changes in the viscosity characteristics of a slurry containing the starch composition for food products of Example 1-2 (starch composition for food products: edible oil/fat: water = 1:2:7) during three freeze-thaw cycles.

[FIG. 3] Photographs representing the properties of a slurry containing the starch composition for food products of Example 1-2 (starch composition for food products: edible oil/fat: water = 1:2:7) at 20° C. during (a) the first freeze-thaw cycle, (b) the second freeze-thaw cycle, and (c) the third freeze-thaw cycle of the three freeze-thaw cycles performed for the slurry.

[FIG. 4] A graph showing changes in the viscosity characteristics of a slurry containing the starch composition for food products of Example 3 (starch composition for food products: edible oil/fat: water = 1:2:7) during three freeze-thaw cycles.

[FIG. 5] Photographs representing the properties of a slurry containing the starch composition for food products of Example 3 (starch composition for food products: edible oil/fat: water = 1:2:7) at 20° C. during (a) the first freeze-thaw cycle, (b) the second freeze-thaw cycle, and (c) the third freeze-thaw cycle of the three freeze-thaw cycles performed for the slurry.

[FIG. 6] A graph showing changes in the viscosity characteristics of a slurry containing the starch composition for food products of Example 5 (starch composition for food products: edible oil/fat: water = 1:2:7) during three freeze-thaw cycles.

[FIG. 7] Photographs representing the properties of a slurry containing the starch composition for food products of Example 5 (starch composition for food products: edible oil/fat: water = 1:2:7) at 20° C. during (a) the first freeze-thaw cycle, (b) the second freeze-thaw cycle, and (c) the third freeze-thaw cycle of the three freeze-thaw cycles performed for the slurry.

[FIG. 8] Microscopic images of ice crystals of (a) Reference example 17 and (b) Example 17.

### DESCRIPTION OF EMBODIMENTS

Hereinafter, each of the embodiments of the present invention will be described in detail.

### 1. Starch Composition for Food Products

A starch composition for food products according to the present invention is a composition containing a starch-lipid complex, namely, a complex of a lipid and a starch selected from the group consisting of a raw starch and modified starches, and comprises a first aspect defined by a characteristic viscosity of a slurry of the starch composition which is obtained by mixing the starch composition with an edible oil/fat and water, and a second aspect defined by raw ingredients and the processing treatment thereof. Hereinafter, each aspect will be described.

### First Aspect

A starch composition for food products according to the first aspect is characterized in that the Brookfield viscosity (Pa•s) of its slurry, which is obtained by mixing the starch composition for food products with an edible oil/fat that is twice as much and water that is 7 times as much as the mass of the starch composition for food products in this order at 20° C. without heating, measured under the conditions of 30 rpm for 30 seconds is not lower than 2 Pa·s and not higher than 100 Pa•s, and
in that the Brookfield viscosity (Pa•s) of the slurry measured under the conditions of 30 rpm for 30 seconds after cooling or heating the slurry satisfies the following condition:
“the Brookfield viscosity at 0° C. is not less than twice and not more than 30 times the Brookfield viscosity at 90° C.”. In a preferred aspect, the above slurry has a rice cake-like viscoelasticity.

As described above, the starch composition for food products according to the first aspect is characterized in that it can form a slurry by mixing it with an edible oil/fat that is twice as much and water that is 7 times as much as the mass of the starch composition for food products in this order at 20° C. without heating. According to a preferred aspect, this slurry is a completely emulsified slurry in which the aqueous and oil phases are not separated. If the aqueous and oil phases are not emulsified and form lumps in the presence of the aforementioned starch composition for food products, such slurries are not included in the slurry mentioned herein. Generally known raw starches and modified starches are not highly water- and oil-absorbent, and therefore when mixed with an edible oil/fat that is twice as much and water that is 7 times as much as the mass of the starch composition for food products in this order, the water phase and oil phase will separate from each other. On the other hand, the starch composition for food products according to the first aspect of the invention is characteristic in that it is highly water- and oil-absorbent, and thus can be emulsified with an edible oil/fat that is twice as much and water that is 7 times as much as the mass of the starch composition for food products and can form a slurry without heating.

The edible oil/fat mentioned above is not particularly limited as long as it is applicable to food products. Examples of the edible oil/fat include one or more selected from the group consisting of: vegetable oils/fats such as soybean oil, rapeseed oil, corn oil, cottonseed oil, rice oil, sunflower oil, safflower oil, sesame oil, olive oil, peanut oil, kapok oil, evening primrose oil, linseed oil, perilla oil, palm oil, palm kernel oil, and coconut oil; animal oils/fats such as fish oil, lard, tallow, and milk fat; triglycerides of medium-chain fatty acids; and processed oils/fats obtained by subjecting these oils/fats to one or more kinds of processing selected from the group consisting of transesterification, hydrogenation, and fractionation. Among these, the edible oil/fat is preferably one or more selected from the group consisting of soybean oil, rapeseed oil, corn oil, cottonseed oil, rice oil, sunflower oil, safflower oil, sesame oil, olive oil, linseed oil, perilla oil, and palm oil, more preferably one or more selected from the group consisting of soybean oil, rapeseed oil, corn oil, sunflower oil, olive oil, and palm oil, and particularly preferably one or more selected from the group consisting of rapeseed oil, olive oil, and palm oil. The starch composition for food products according to the first aspect of the invention should be one that exhibits the viscosity characteristics described above when one or more of the above oils are used as the edible oil/fat.

Preferably, the slurry has rice cake-like viscoelasticity as one of its characteristic properties. Herein, “rice cake-like viscoelasticity” means that when a portion of the slurry is scooped up, it shows a rice cake-like physical property in that it stretches uninterruptedly due to its own viscoelasticity.

As described above, the aforementioned slurry can take a form of a viscous fluid under given conditions. In a preferred aspect of the present invention, the starch composition for food products according to the first aspect of the invention can be blended into a food product or an ingredient composition thereof together with an edible oil/fat and water or together with water to impart pleasant meltability in mouth or a thick, smooth texture to the food product.

Furthermore, the Brookfield viscosity (Pa•s) of the aforementioned slurry in unheated state (about 20° C.) measured under the conditions of 30 rpm for 30 seconds is not lower than 2 Pa•s and not higher than 100 Pa•s, and the Brookfield viscosity (Pa•s) of the aforementioned slurry measured under the conditions of 30 rpm for 30 seconds after cooling or heating the slurry satisfies the following condition:

“the Brookfield viscosity (Pa•s) at 0° C. is not less than twice and not more than 30 times the Brookfield viscosity at 90° C.”.

As described above, the starch composition for food products according to the first aspect is characterized in that the Brookfield viscosity of its slurry obtained by mixing the starch composition for food products with an edible oil/fat that is twice as much and water that is 7 times as much as the mass of the starch composition for food products is temperature-dependent, where the viscosity becomes lower at higher temperatures and higher at lower temperatures. Due to this characteristic, the starch composition for food products according to the first aspect of the invention is easy to handle by having low viscosity at a high temperature when it is blended into the ingredient mixture of the food product containing an edible oil/fat and water in the manufacturing process of the food product, while it can impart a dense texture with high viscosity and resilience to the final product at a low temperature. Also, when the product is consumed and warmed in the mouth and becomes less viscous, it can give pleasant meltability in mouth with a thick, rich taste.

The Brookfield viscosity (Pa•s) of the slurry in unheated state (about 20° C.) is preferably not lower than 2.5 Pa•s and not higher than 100 Pa•s, more preferably not lower than 2.5 Pa•s and not higher than 95 Pa•s, and still more preferably not lower than 2.5 Pa·s and not higher than 85 Pa•s.

The Brookfield viscosity of the slurry at 0° C. is preferably not less than twice and not more than 30 times, more preferably not less than twice and not more than 20 times, still more preferably not less than twice and not more than 18 times, and particularly preferably not less than twice and not more than 15 times the Brookfield viscosity of said slurry at 90° C.

Furthermore, the Brookfield viscosity (Pa•s) of the slurry at 0° C. is preferably not lower than 5 Pa•s and not higher than 300 Pa•s, more preferably not lower than 5 Pa·s and not higher than 250 Pa•s, and still more preferably not lower than 5 Pa•s and not higher than 200 Pa•s. For example, if the Brookfield viscosity of the aforementioned slurry at 0° C. is within the above range, when the starch composition for food products is blended into a confection that is served at or below body temperature (e.g., frozen dessert), it can impart a moderately resilient, dense texture and can provide smooth meltability in mouth with a thicker, richer texture upon eating.

Preferably, the slurry is also resistant against freeze-thaw cycle.

For example, the difference between the Brookfield viscosities (Pa•s) of the slurry at the temperatures of 20° C., 30° C., 40° C., 50° C. and 60° C. when the freeze-thaw cycle is repeated three times under the following conditions and the Brookfield viscosities (Pa•s) at the corresponding temperatures before the freeze-thaw cycle is within 10.0 Pa•s. This difference is more preferably within 8 Pa•s, and still more preferably within 5 Pa•s.
“<Conditions for freeze-thaw cycles>
for the first cycle, the slurry prepared at room temperature is cooled to -10° C. at a cooling rate of -1° C./min and kept in that state for at least 15 hours, then the slurry is heated to reach 60° C. at a heating rate of 45° C./min, and then cooled again to -10° C. at a cooling rate of -1° C./min and kept in that state for at least 15 hours; and
for the second cycle and on, the slurry that went through the first cycle is heated to reach 60° C. at a heating rate of 45° C./min and then cooled again to -10° C. at a cooling rate of -1° C./min and kept in that state for at least 15 hours.”

According to a preferred aspect, since the viscosity characteristics of the slurry do not change greatly in the temperature range of 20° C. to 60° C., i.e., at the time of consumption, even when the freeze-thaw cycle is repeated for three times under the above conditions, it can ensure stable product quality against temperature changes expected during distribution of the product.

In each freezing cycle, the cooling state is sufficiently stabilized by keeping the cooling state for at least 15 hours. For example, the cooling state may be kept for 24 or 48 hours. The upper limit of the time to maintain the cooling state is not particularly limited, but it is preferably 1,440 hours or shorter considering the effects caused by ice crystal growth.

Herein, the Brookfield viscosity of the slurry refers to the value measured with a No. 4 rotor for a Brookfield viscometer under the conditions of 30 rpm for 30 seconds. Although the container is covered with plastic wrap to prevent evaporation of moisture when heating the slurry and the measurement is performed immediately after reaching the specified temperature, an error in the Brookfield viscosity may occur due to partial evaporation of moisture and other factors. In this case, the Brookfield viscosity is acceptable if the Brookfield viscosity of the slurry that reaches 0° C. or 90° C. for the first time after its preparation satisfies the above conditions. Alternatively, water may be added to compensate the loss of the evaporated moisture before the next freeze-thaw cycle to minimize the error.

The temperature at which the slurry is prepared for the freezing cycle is not limited as long as it is at room temperature. For example, it is preferably 25° C. ± 5° C.

The starch composition for food products according to the first aspect of the present invention is a composition containing a starch-lipid complex, which is a complex of a lipid and a starch selected from the group consisting of a raw starch and modified starches as described above, where the raw ingredients and the processing treatment thereof are not particularly limited as long as the composition has the above-described characteristic properties. Herein, the term “starch-lipid complex” refers to a complex formed by the interaction between a lipid and one or more selected from the group consisting of a raw starch and modified starches of said raw starch.

Specific examples of the starch composition for food products according to the first aspect of the invention include those obtained by subjecting a polyglycerol fatty acid ester as a lipid and one or more selected from the group consisting of raw potato starch and modified starches of said raw potato starch to a heat treatment under a pressure condition of 0 MPa or higher but lower than 100 MPa. The heat treatment is preferably performed in the presence of water. The starch composition for food products preferably contains, as a component derived from a starch selected from the group consisting of a raw starch and modified starches, a starch-lipid complex which is formed from a polyglycerol fatty acid ester and one or more selected from the group consisting of raw potato starch and modified starches of said raw potato starch. In this case, the “starch-lipid complex” is formed by the interaction between a polyglycerol fatty acid ester and one or more selected from the group consisting of raw potato starch and modified starches of said raw potato starch. This “starch-lipid complex” will be explained in more detail in “(2) Second aspect”.

The modified starch of raw potato starch is preferably a modified starch obtained by subjecting the raw potato starch to one or more modification treatments selected from the group consisting of cross-linking, hydroxypropylation, and esterification. Examples of the modification treatment include one or more of: cross-linking such as phosphate cross-linking and adipate cross-linking; hydroxypropylation; monoesterification such as phosphate monoesterification; and the like. Specifically, the modified starch is preferably hydroxypropyl potato starch, distarch phosphate potato starch, and hydroxypropyl distarch phosphate potato starch, and particularly preferably hydroxypropyl potato starch or distarch phosphate potato starch.

While the fatty acid of the polyglycerol fatty acid ester is not particularly limited, it is preferably one or more selected from the group consisting of myristic acid, palmitic acid, stearic acid, oleic acid, and behenic acid, and more preferably one or two selected from the group consisting of palmitic acid and stearic acid.

The polyglycerol fatty acid ester preferably has a HLB value of not lower than 1 and not higher than 13 and an average degree of polymerization of not less than 2 and not more than 9. Here, the HLB value is more preferably not lower than 1 and not higher than 11, and still more preferably not lower than 3 and not higher than 10. The average degree of polymerization is more preferably not less than 2 and not more than 7, and still more preferably not less than 2 and not more than 5. Herein, the average degree of polymerization of polyglycerol is determined by calculating from the hydroxyl value, or by determining the composition of polyglycerol by gas chromatography, liquid chromatography, thin-layer chromatography, gas chromatography-mass spectrometry, or liquid chromatography-mass spectrometry to calculate the average degree of polymerization.

While the mass ratio of the polyglycerol fatty acid ester to 100 parts by mass of the one or more raw material starches selected from the group consisting of raw potato starch and modified starches of said raw potato starch is not particularly limited, it is preferably not less than 0.01 and not more than 4.8 parts by mass, more preferably not less than 0.1 and not more than 4.5 parts by mass, still more preferably not less than 0.85 and not more than 4.5 parts by mass, and yet still more preferably not less than 1.0 and not more than 4.0 parts by mass.

The starch composition for food products according to the first aspect of the invention can be obtained, for example, by adding water to an ingredient mixture containing a polyglycerol fatty acid ester, one or more selected from the group consisting of raw potato starch and modified starches of said raw potato starch, and, if necessary, a small amount (e.g., not less than 0.1% and not more than 2% by mass in the ingredient mixture) of an insoluble salt such as calcium carbonate, and subjecting the mixture to a heat treatment using an extruder or drum dryer.

### <Heat Treatment Using Extruder>

For example, if an extruder is used for the heat treatment, water is added to an ingredient mixture containing a polyglycerol fatty acid ester and one or more selected from the group consisting of raw potato starch and modified starches of raw potato starch to adjust the moisture content to be roughly not less than 10% and not more than 60% by mass relative to the mass of the composition containing the ingredient mixture and water. Then, the ingredient mixture is heated and expanded under the following conditions: barrel temperature not lower than 30° C. and not higher than 200° C., outlet temperature not lower than 80° C. and not higher than 180° C., screw speed not lower than 100 rpm and not higher than 1000 rpm, and time of heat treatment not shorter than 5 seconds and not longer than 60 seconds, thereby obtaining a starch composition for food products of interest.

Here, as for the temperature conditions, the barrel temperature is more preferably not lower than 30° C. and not higher than 170° C. and still more preferably not lower than 30° C. and not higher than 140° C., and the outlet temperature is more preferably not lower than 100° C. and not higher than 160° C. and still more preferably not lower than 110° C. and not higher than 145° C.

As for the conditions for adding water, it is more preferable to adjust the moisture content to be not less than 15% and not more than 40% by mass, and still more preferable to adjust it to be not less than 20% and not more than 30% by mass relative to the mass of the composition containing the ingredient mixture and water.

The screw speed is more preferably not lower than 150 rpm and not higher than 900 rpm and still more preferably not lower than 200 rpm and not higher than 850 rpm.

The pressure condition is preferably not lower than 0.5 MPa and not higher than 100 MPa, more preferably not lower than 0.5 MPa and not higher than 80 MPa, still more preferably not lower than 0.5 MPa and not higher than 50 MPa, particularly preferably not lower than 0.5 MPa and not higher than 30 MPa, and even more preferably not lower than 0.5 MPa and not higher than 20 MPa.

Moreover, the time for heat treatment is more preferably not shorter than 7 seconds and not longer than 50 seconds and still more preferably not shorter than 10 seconds and not longer than 45 seconds.

### <Heat Treatment Using Drum Dryer>

If a drum dryer is used for the heat treatment, water is added to an ingredient mixture containing a polyglycerol fatty acid ester and one or more selected from the group consisting of raw potato starch and modified starches of said raw potato starch to prepare a slurry in which the concentration of the ingredient mixture is not less than 20% w/w and not more than 45% w/w (roughly not less than 10 and not more than 22 degrees Baumé). Then, the slurry is passed through heat transfer apparatus “ONLATOR” (registered trademark) and heated to an outlet temperature of roughly not lower than 90° C. and not higher than 140° C. under a pressure condition of not lower than 0 MPa and not higher than 0.5 MPa, to prepare a paste liquid, which is preferably spread thinly on a drum dryer that is heated to a temperature of not lower than 100° C. and not higher than 200° C. for heat drying. After the heat treatment, the heat-dried material can be scraped from the drum dryer to obtain a starch composition for food products of interest.

Here, as temperature conditions, the outlet temperature is more preferably not lower than 95° C. and not higher than 140° C. and still more preferably not lower than 100° C. and not higher than 130° C., and the drum dryer temperature is more preferably not lower than 110° C. and not higher than 190° C., and still more preferably not lower than 120° C. and not higher than 180° C.

As for the conditions for adding water, the concentration of the ingredient mixture in the slurry is preferably in a range not less than 22% w/w and not more than 40% w/w (roughly not less than 10.5 and not more than 20 degrees Baumé), and more preferably in a range not less than 24% w/w and not more than 38% w/w (roughly not less than 11 and not more than 19 degrees Baumé).

The pressure condition is preferably not lower than 0.05 MPa and not higher than 0.48 MPa, and more preferably not lower than 0.07 MPa and not higher than 0.45 MPa.

The ingredient mixture can be subjected to a heat treatment under the above conditions, preferably in the presence of water, thereby obtaining the starch composition for food products of interest. As described above, there is no need of treating under a high pressure in any of the heat treatments, and the starch composition for food products of interest can be obtained under the pressure condition of lower than 100 MPa, preferably lower than 80 MPa, and more preferably lower than 50 MPa.

As described above, since the starch composition for food products according to the first aspect can exhibit characteristic properties by being mixed with an edible oil/fat and water, it can be used in a food product together with an edible oil/fat and water to improve the texture of the food product and or to impart a new texture to the food product. The slurry or the emulsified composition obtained by mixing the starch composition for food products according to the first aspect with an edible oil/fat and water changes its viscosity depending on temperature, where it has low viscosity and good workability at high temperatures, which is advantageous in the manufacturing process, while it can impart a dense texture with high viscosity and resilience to the food product at low temperatures. Therefore, when it is used in a food product, such as a frozen dessert, it can be easily handled and it can impart pleasant meltability in mouth upon eating and a thick texture to the food product.

### Second Aspect

A starch composition for food products according to a second aspect of the invention is obtained by subjecting a polyglycerol fatty acid ester and one or more selected from the group consisting of raw potato starch and modified starches of said raw potato starch to a heat treatment under a pressure condition of 0 MPa or higher but lower than 100 MPa, wherein the starch composition is characterized by containing a starch-lipid complex.

Herein, the term “starch-lipid complex” refers to a complex formed by the interaction between a polyglycerol fatty acid ester and one or more of the group consisting of raw potato starch and modified starches of said raw potato starch. Although it is not easy to identify its specific structure and there are still many parts that remain to be elucidated, it is thought, for example, that the polyglycerol fatty acid esters are entrapped in the helical structure of amylose molecules in the one or more starches selected from the group consisting of raw potato starch and modified starches of said raw potato starch. Alternatively, polyglycerol fatty acid esters may be attached to the surface of the helical structure of said amylose molecules. Alternatively, it is also possible that polyglycerol fatty acid esters are interacting with parts other than the aforementioned amylose molecules. In this complex, the starch may be a low-molecular-weight starch due to cleavage of the starch chain or a high-molecular-weight starch due to polymerization of the starch chains, or it may contain both.

The modified starch of raw potato starch is preferably a modified starch obtained by subjecting the raw potato starch to one or more modification treatments selected from the group consisting of cross-linking, hydroxypropylation, and esterification. Examples of the modification treatment include one or more of: cross-linking such as phosphate cross-linking and adipate cross-linking; hydroxypropylation; monoesterification such as phosphate monoesterification; and the like. Specifically, the modified starch is preferably hydroxypropyl potato starch, distarch phosphate potato starch, and hydroxypropyl distarch phosphate potato starch, and particularly preferably hydroxypropyl potato starch or distarch phosphate potato starch.

While the fatty acid of the polyglycerol fatty acid ester is not particularly limited, it is preferably one or more selected from myristic acid, palmitic acid, stearic acid, oleic acid, and behenic acid, and more preferably one or two selected from the group consisting of palmitic acid and stearic acid.

The polyglycerol fatty acid ester preferably has a HLB value of not lower than 1 and not higher than 13 and an average degree of polymerization of not less than 2 and not more than 9. Here, the HLB value is more preferably not lower than 1 and not higher than 11, and still more preferably not lower than 3 and not higher than 10. The average degree of polymerization is more preferably not less than 2 and not more than 7, and still more preferably not less than 2 and not more than 5.

While the mass ratio of the polyglycerol fatty acid ester to 100 parts by mass of the one or more raw material starches selected from the group consisting of raw potato starch and modified starches of said raw potato starch is not particularly limited, it is preferably not less than 0.01 and not more than 4.8 parts by mass, more preferably not less than 0.1 and not more than 4.5 parts by mass, and still more preferably not less than 1.0 and not more than 4.0 parts by mass.

The starch composition for food products according to the second aspect of the invention can be obtained, for example, by adding water to an ingredient mixture containing a polyglycerol fatty acid ester, one or more selected from the group consisting of raw potato starch and modified starches of said raw potato starch, and, if necessary, a small amount (e.g., not less than 0.1% and not more than 2% by mass in the ingredient mixture) of an insoluble salt such as calcium carbonate, and subjecting the mixture to a heat treatment using an extruder or drum dryer.

The process and conditions of the heat treatment using an extruder or drum dryer are as described in “(1) First aspect” above. As described above, the ingredient mixture can be subjected to a heat treatment under predetermined pressure conditions, preferably in the presence of water, thereby obtaining the starch composition for food products of interest.

In the starch composition for food products of the present invention, the starch-lipid complex may be formed at least in part. For example, the content of the starch-lipid complex may be not less than 0.1% and not more than 1.8% by mass, preferably not less than 0.3% and not more than 1.7% by mass, and more preferably not less than 0.5% and not more than 1.5% by mass in the starch composition for food products. The rest of the components in the starch composition for food products are derived from the raw ingredients including the polyglycerol fatty acid ester and the one or more selected from the group consisting of raw potato starch and modified starches of said raw potato starch.

According to a preferred aspect, the starch composition for food products according to the second aspect has the following characteristic properties.

For example, in a preferred aspect of the invention, the starch composition for food products according to the second aspect is characterized in that it can form a slurry by being mixed with an edible oil/fat that is twice as much and water that is 7 times as much as the mass of the starch composition for food products in this order at 20° C. without heating. According to a more preferred aspect, this slurry is in a completely emulsified state where the aqueous and oil phases are not separated. Here, it is preferable to use the same edible oil/fat as that described in “(1) First aspect” above.

The slurry preferably has a rice cake-like viscoelasticity. Here, the “rice cake-like viscoelasticity” is as described in “(1) First aspect” above. The slurry is a viscous fluid as described above. The starch composition for food products according to the second aspect of the invention can be blended into a food product together with an edible oil/fat and water to form a viscous fluid, thereby imparting pleasant meltability in mouth with a thick, smooth texture to the food product.

Furthermore, the Brookfield viscosity (Pa•s) of the aforementioned slurry in unheated state (about 20° C.) measured under the conditions of 30 rpm for 30 seconds is not lower than 2 Pa•s and not higher than 100 Pa•s, and the Brookfield viscosity (Pa•s) of the aforementioned slurry measured under the conditions of 30 rpm for 30 seconds after cooling or heating the slurry preferably satisfies the following condition:

“the Brookfield viscosity (Pa·s) at 0° C. is not less than twice and not more than 30 times the Brookfield viscosity at 90° C.”.

Thus, the starch composition for food products according to the second aspect is also preferably characteristic in that the Brookfield viscosity of the aforementioned slurry is temperature dependent such that its viscosity becomes lower at higher temperatures and higher at lower temperatures, and due to this characteristics, the starch composition for food products according to the second aspect of the invention is easy to be handled at a high temperature when it is blended into the ingredient mixture of the food product containing an edible oil/fat and water in the manufacturing process of the food product, while it can impart a dense texture with resilience to the final product at a low temperature. In addition, when the food product is consumed and warmed in the mouth, it can give pleasant meltability in mouth with a thick, rich texture.

The Brookfield viscosity (Pa•s) of the slurry in unheated state (about 20° C.) is preferably not lower than 2.5 Pa•s and not higher than 100 Pa·s, more preferably not lower than 2.5 Pa•s and not higher than 95 Pa·s, and still more preferably not lower than 2.5 Pa·s and not higher than 85 Pa·s.

The Brookfield viscosity of the slurry at 0° C. is preferably not less than twice and not more than 30 times, more preferably not less than twice and not more than 20 times, still more preferably not less than twice and not more than 18 times, and particularly preferably not less than twice and not more than 15 times the Brookfield viscosity of said slurry at 90° C.

Furthermore, the Brookfield viscosity (Pa•s) of the slurry at 0° C. is preferably not lower than 5 Pa•s and not higher than 300 Pa•s, more preferably not lower than 5 Pa·s and not higher than 250 Pa•s, and still more preferably not lower than 5 Pa•s and not higher than 200 Pa•s. For example, if the Brookfield viscosity of the aforementioned slurry at 0° C. is within the above range, when the starch composition for food products is blended into a confection that is served at or below body temperature (e.g., frozen dessert), it can impart a moderately resilient, dense texture and can provide smooth meltability in mouth with a thicker, richer texture upon eating.

Preferably, the slurry is also resistant against freeze-thaw cycle.

For example, the difference between the Brookfield viscosities (Pa·s) of the slurry at the temperatures of 20° C., 30° C., 40° C., 50° C. and 60° C. when the freeze-thaw cycle is repeated three times under the following conditions and the Brookfield viscosities (Pa•s) at the corresponding temperatures before the freeze-thaw cycle is within 10.0 Pa·s. This difference is more preferably within 8 Pa·s, and still more preferably within 5 Pa·s.
“<Conditions for freeze-thaw cycles>
for the first cycle, the slurry prepared at room temperature is cooled to -10° C. at a cooling rate of -1° C./min and kept in that state for at least 15 hours, then the slurry is heated to reach 60° C. at a heating rate of 45° C./min, and then cooled again to -10° C. at a cooling rate of -1° C./min and kept in that state for at least 15 hours; and
for the second cycle and on, the slurry that went through the first cycle is heated to reach 60° C. at a heating rate of 45° C./min and then cooled again to -10° C. at a cooling rate of -1° C./min and kept in that state for at least 15 hours.”

According to a preferred aspect, since the viscosity characteristics of the slurry do not change greatly in the temperature range of 20° C. to 60° C., i.e., at the time of consumption, even when the freeze-thaw cycle is repeated for three times under the above conditions, it can ensure stable product quality against temperature changes expected during distribution of the product.

The physical properties of a slurry that is obtained by adding an edible oil/fat and water to the starch composition for food products in a predetermined quantity ratio has been described above. However, the ratio of the edible oil/fat and water to the starch composition for food products is not limited to the above. According to one embodiment of the invention, addition of the starch composition for food products plus water to a food product has a reasonable effect, such as imparting a pleasant meltability in mouth with a thick, smooth texture to the food product, without necessarily adding an edible oil/fat.

### 2. Method for Producing Starch Composition for Food Products

A method for producing a starch composition for food products is characterized by comprising a step of subjecting an ingredient mixture containing a polyglycerol fatty acid ester and one or more selected from the group consisting of raw potato starch and modified starches of said raw potato starch to a heat treatment under a pressure condition of 0 MPa or higher but lower than 100 MPa.

The starch composition for food products preferably contains, as a component derived from a starch selected from the group consisting of a raw starch and modified starches, a starch-lipid complex which is formed from a polyglycerol fatty acid ester and one or more selected from the group consisting of raw potato starch and modified starches of said raw potato starch. Herein, the term “starch-lipid complex” refers to a complex formed by the interaction between a polyglycerol fatty acid ester and one or more of the group consisting of raw potato starch and modified starches of said raw potato starch. The details are as described in “(2) Second aspect” above.

The modified starch of raw potato starch is preferably a modified starch obtained by subjecting the raw potato starch to one or more modification treatments selected from the group consisting of cross-linking, hydroxypropylation, and esterification. Examples of the modification treatment include one or more of: cross-linking such as phosphate cross-linking and adipate cross-linking; hydroxypropylation; monoesterification such as phosphate monoesterification; and the like. Specifically, the modified starch is preferably hydroxypropyl potato starch, distarch phosphate potato starch, and hydroxypropyl distarch phosphate potato starch, and particularly preferably hydroxypropyl potato starch or distarch phosphate potato starch.

While the fatty acid of the polyglycerol fatty acid ester is not particularly limited, it is preferably one or more selected from myristic acid, palmitic acid, stearic acid, oleic acid, and behenic acid, and more preferably one or two selected from the group consisting of palmitic acid and stearic acid.

The polyglycerol fatty acid ester preferably has a HLB value of not lower than 1 and not higher than 13 and an average degree of polymerization of not less than 2 and not more than 9. Moreover, the HLB value is more preferably not lower than 1 and not higher than 11, and still more preferably not lower than 3 and not higher than 10. The average degree of polymerization is more preferably not less than 2 and not more than 7, and still more preferably not less than 2 and not more than 5.

While the mass ratio of the polyglycerol fatty acid ester to 100 parts by mass of the one or more raw material starches selected from the group consisting of raw potato starch and modified starches of said raw potato starch, contained in the ingredient mixture, is not particularly limited, it is preferably not less than 0.01 and not more than 4.8 parts by mass, more preferably not less than 0.1 and not more than 4.5 parts by mass, and still more preferably not less than 1 and not more than 4.0 parts by mass.

Other than the raw potato starch, modified starch of the raw potato starch, and polyglycerol fatty acid ester, the ingredient mixture may also contain an insoluble salt as long as the effect of the invention is not impaired. An insoluble salt may be, for example, calcium carbonate. Calcium carbonate is preferably contained in the ingredient mixture in an amount of not less than 0.1% and not more than 2% by mass.

In the heat treatment process, the ingredient mixture is subjected to a heat treatment under predetermined pressure conditions, preferably in the presence of water.

For example, water is added to the ingredient mixture containing the polyglycerol fatty acid ester and the one or more selected from the group consisting of raw potato starch and modified starches of said raw potato starch, and the mixture is subjected to a heat treatment using an extruder or drum dryer.

The process and conditions of the heat treatment using an extruder or drum dryer are as described in “(1) First aspect” above. As described above, the ingredient mixture can be subjected to a heat treatment under a pressure condition of 0 MPa to lower than 100 MPa, preferably in the presence of water, thereby obtaining the starch composition for food products of interest. According to a preferred aspect, the heat treatment process comprises performing a heat treatment by pressurizing and extruding the ingredient mixture using an extruder.

After the heat treatment, if necessary, the method may further comprise the steps of pulverizing and sieving the starch composition for food products. For pulverizing and sieving, known equipment and process can be employed as needed.

The particle size of the starch composition for food products is preferably such that the content of the fraction (particles) that is sieved through a JIS-Z8801-1 standard sieve with an aperture size of 0.25 mm and that remains on a JIS-Z8801-1 standard sieve with an aperture size of 0.075 mm is not less than 30% and not more than 85% by mass.

The starch composition for food products obtained by the method described above can have the same characteristic properties as those described in “(1) First aspect” and “(2) Second aspect” above.

For example, the starch composition for food products obtained by the method described above is characterized in that it can form a slurry by being mixed with an edible oil/fat that is twice as much and water that is 7 times as much as the mass of the starch composition for food products in this order at 20° C. without heating. According to a more preferred aspect, this slurry is in a completely emulsified state where the aqueous and oil phases are not separated. Here, it is preferable to use the same edible oil/fat as that described in “(1) First aspect” above.

The slurry preferably has a rice cake-like viscoelasticity. Here, the “rice cake-like viscoelasticity” is as described in “(1) First aspect” above. The slurry is a viscous fluid as described above. The starch composition for food products obtained by the method described above can be blended into a food product together with an edible oil/fat and water to form a viscous fluid, thereby imparting pleasant meltability in mouth with a thick, smooth texture to the food product.

Furthermore, the Brookfield viscosity (Pa·s) of the aforementioned slurry in unheated state (about 20° C.) measured under the conditions of 30 rpm for 30 seconds is not lower than 2 Pa·s and not higher than 100 Pa·s, and the Brookfield viscosity (Pa•s) of the aforementioned slurry measured under the conditions of 30 rpm for 30 seconds after cooling or heating the slurry preferably satisfies the following condition:

“the Brookfield viscosity (Pa·s) at 0° C. is not less than twice and not more than 30 times the Brookfield viscosity at 90° C.”.

Thus, the starch composition for food products obtained by the method described above is also preferably characteristic in that the Brookfield viscosity of the aforementioned slurry changes depending on the temperature, and due to this characteristic, the starch composition for food products obtained by the method described above is easy to handle by having low viscosity at a high temperature when it is blended into the ingredient mixture of the food product containing an edible oil/fat and water in the manufacturing process of the food product, while it can impart a dense texture with high viscosity and resilience to the final product at a low temperature. Also, when the product is consumed and warmed in the mouth, it can give pleasant meltability in mouth with a thick, rich texture.

The Brookfield viscosity (Pa·s) of the slurry in unheated state (about 20° C.) is preferably not lower than 2.5 Pa•s and not higher than 100 Pa·s, more preferably not lower than 2.5 Pa·s and not higher than 95 Pa·s, and still more preferably not lower than 2.5 Pa·s and not higher than 85 Pa·s.

The Brookfield viscosity of the slurry at 0° C. is preferably not less than twice and not more than 30 times, more preferably not less than twice and not more than 20 times, still more preferably not less than twice and not more than 18 times, and particularly preferably not less than twice and not more than 15 times the Brookfield viscosity of said slurry at 90° C.

Furthermore, the Brookfield viscosity (Pa•s) of the slurry at 0° C. is preferably not lower than 5 Pa·s and not higher than 300 Pa•s, more preferably not lower than 5 Pa·s and not higher than 250 Pa·s, and still more preferably not lower than 5 Pa•s and not higher than 200 Pa·s. For example, if the Brookfield viscosity of the aforementioned slurry at 0° C. is within the above range, when the starch composition for food products is blended into a confection that is served at or below body temperature (e.g., frozen dessert), it can impart a moderately resilient, dense texture and can provide smooth meltability in mouth with a thick, rich taste upon eating.

Preferably, the slurry is also resistant against freeze-thaw cycle.

For example, the difference between the Brookfield viscosities (Pa•s) of the slurry at the temperatures of 20° C., 30° C., 40° C., 50° C. and 60° C. when the freeze-thaw cycle is repeated three times under the following conditions and the Brookfield viscosities (Pa•s) at the corresponding temperatures before the freeze-thaw cycle is within 10.0 Pa•s. This difference is more preferably within 8 Pa•s, and still more preferably within 5 Pa•s.
“<Conditions for freeze-thaw cycles>
for the first cycle, the slurry prepared at room temperature is cooled to -10° C. at a cooling rate of -1° C./min and kept in that state for at least 15 hours, then the slurry is heated to reach 60° C. at a heating rate of 45° C./min, and then cooled again to -10° C. at a cooling rate of -1° C./min and kept in that state for at least 15 hours; and
for the second cycle and on, the slurry that went through the first cycle is heated to reach 60° C. at a heating rate of 45° C./min and then cooled again to -10° C. at a cooling rate of -1° C./min and kept in that state for at least 15 hours.”

According to a preferred aspect, since the viscosity characteristics of the slurry do not change greatly in the temperature range of 20° C. to 60° C., i.e., at the time of consumption, even when the freeze-thaw cycle is repeated for three times under the above conditions, it can ensure stable product quality against temperature changes expected during distribution of the product.

### 3. Emulsified Composition

An emulsified composition according to the present invention is characterized by comprising the above-described starch composition for food products, an edible oil/fat that is not less than 0.5 times and not more than 10 times the mass of the starch composition for food products, and water that is not less than 0.5 times and not more than 10 times the mass of the starch composition for food products. Here, the mass of the edible oil/fat blended is preferably not less than 0.5 times and not more than 6 times and more preferably not less than 1 time and not more than 6 times the mass of the aforementioned starch composition for food products. Here, the mass of water blended is preferably not less than twice and not more than 10 times and more preferably not less than twice and not more than 9 times the mass of the aforementioned starch composition for food products.

The emulsified composition of the present invention can be obtained by mixing the above-described starch composition for food products, an edible oil/fat, and water in a predetermined quantity ratio.

In a preferred aspect, the emulsified composition of the present invention has a rice cake-like viscoelasticity and has properties such as a temperature-dependent Brookfield viscosity where it has higher Brookfield viscosity at lower temperatures and lower Brookfield viscosity at higher temperatures. Due to this characteristic, when the emulsified composition of the present invention is blended into a food product, it can impart pleasant meltability in mouth and a texture such as a thick, rich texture to the food product.

The aforementioned starch composition for food products used in the emulsified composition of the present invention is as described in “1. Starch composition for food products” above.

The edible oil/fat mentioned above used in the emulsified composition of the present invention is not particularly limited as long as it is applicable to food products. Examples of the edible oil/fat include one or more selected from the group consisting of: vegetable oils/fats such as soybean oil, rapeseed oil, corn oil, cottonseed oil, rice oil, sunflower oil, safflower oil, sesame oil, olive oil, peanut oil, kapok oil, evening primrose oil, linseed oil, perilla oil, palm oil, palm kernel oil, and coconut oil; animal oils/fats such as fish oil, lard, tallow, and milk fat; triglycerides of medium-chain fatty acids; and processed oils/fats obtained by subjecting these oils/fats to one or more kinds of processing selected from the group consisting of transesterification, hydrogenation, and fractionation. Among these, the edible oil/fat is preferably one or more selected from the group consisting of soybean oil, rapeseed oil, corn oil, cottonseed oil, rice oil, sunflower oil, safflower oil, sesame oil, olive oil, linseed oil, perilla oil, and palm oil, more preferably one or more selected from the group consisting of soybean oil, rapeseed oil, corn oil, sunflower oil, olive oil, and palm oil, and particularly preferably one or more selected from the group consisting of rapeseed oil, olive oil, and palm oil. The edible oil/fat mentioned above can be selected appropriately according to the food product into which the emulsified composition is to be blended, and is applicable preferably as long as it can have a rice cake-like viscoelasticity.

The type of water is not particularly limited as long as it can be used for food products and may be, for example, natural water or tap water. Alternatively, instead of water, a water-containing liquid, for example, dairy milk, such as cow’s milk; plant-based milk, such as soy and almond milk; and plant juice, such as fruit juice and vegetable juice, may also be used as water. If a water-containing liquid is used, the amount of water contained in said liquid should meet the aforementioned content.

In the food product manufacturing process, the emulsified composition may be prepared in advance and then added to the ingredient composition of the food product, or the emulsified composition may be prepared by adding and mixing the starch composition for food products, edible oil/fat, and water along with other ingredients. In either case, it is preferable to prepare the emulsified composition by adding and mixing the edible oil/fat and water in this order with the aforementioned starch composition for food products.

If necessary, the emulsified composition may contain an emulsifier, antioxidant, pH adjuster, polysaccharide thickener, seasoning, flavoring, and the like which are generally used in the food product industry.

In the above-described emulsified composition, the total content of the starch composition for food products, edible oil/fat, and water is preferably 70% or more by mass, more preferably 80% or more by mass, still more preferably 90% or more by mass, particularly preferably 95% or more by mass, and even more preferably 99% or more by mass relative to the mass of the emulsified composition.

### 4. Food Product

A food product of the present invention is not particularly limited as long as it contains the above-described starch composition for food products or emulsified composition. Examples of the food product include: confections such as frozen desserts, jellies, baked goods, puddings, mousses, and crepes; bakery products; noodles such as soba and udon; dairy products such as yogurt; plant-based dairy alternatives such as vegetable yogurt; plant-based milk such as soymilk and rice milk; bean curd; sauces such as curry, pasta sauce, white sauce, and pork cutlet sauce; seasonings such as dressings and wasabi paste; beverages such as juices, dairy drinks, and smoothies; meat products; soups such as hot pot soup, corn soup, and potage; fillings such as tuna mayonnaise, caramel, milk, and mayonnaise; fruit sauces and purees such as mango sauces and mango purees; egg dishes such as Japanese rolled omelets, omelets, and omelet stuffed with rice; flour-based dishes such as Takoyaki (octopus balls); and a variety of processed food products such as frozen food products.

Among these, frozen desserts are favorable in that they can readily bring out the characteristic properties of the starch composition for food products or the emulsified composition. Frozen desserts are not particularly limited as long as they are confections served at or below body temperature. Examples of the frozen dessert preferably include ice cream, ice milk (ice cream-like product containing at least 10.0% milk solids), lacto ice cream (ice cream-like product containing at least 3.0% milk solids), ice confections (ice cream-like product other than ice cream, ice milk and lacto ice cream), ice cream sauce, frozen cakes, and frozen cream puffs.

The amount of the starch composition for food products or the emulsion composition blended is not particularly limited and can be adjusted according to the type of the food product, application and purpose. As a rough guide, for example, the amount of the starch composition for food products blended into an ice cream, ice milk, lacto ice cream, ice confection or ice sauce is preferably not less than 0.05% and not more than 30% by mass, more preferably not less than 0.1% and not more than 25% by mass, and still more preferably not less than 0.25% and not more than 20% by mass relative to the mass of the ingredient composition of the food product. As long as the amount of the starch composition for food products is within the above range, pleasant meltability in mouth with a thick texture can be imparted to the frozen dessert. As long as the amount of the starch composition for food products is within the above range, pleasant meltability in mouth with a thick texture can be imparted even when the starch composition is blended into other food products. The amount of the emulsified composition blended should be such that the starch composition for food products contained in the emulsion composition is in the above range.

Although it is preferable to blend the starch composition for food products with both edible oil/fat and water in order to achieve the characteristic properties of the starch composition for food products, a reasonable effect can be obtained even when the starch composition is blended with water only. If an edible oil/fat is blended, however, it can impart a thick, rich texture to the food product.

When an edible oil/fat is blended together with the starch composition for food products, the mass of the edible oil/fat blended is preferably not less than 0.5 times and not more than 10 times, more preferably not less than 0.5 times and not more than 6 times, and still more preferably not less than 1 time and not more than 6 times the mass of said starch composition for food products.

Moreover when water is blended together with the starch composition for food products, the mass of water blended is preferably not less than 0.5 times and not more than 10 times, more preferably not less than twice and not more than 10 times, and still more preferably not less than twice and not more than 9 times the mass of said starch composition for food products.

Specific examples of the edible oil/fat and water that are to be blended together with the above-described starch composition for food products are the same as those exemplified in “3. Emulsified composition” above.

### 5. Method for Imparting Thick Texture to Frozen Dessert

The present invention further provides a method for imparting a thick texture to a frozen dessert by blending the starch composition for food products or the emulsified composition described above into the frozen dessert.

The starch composition for food products or the emulsified composition described above can be blended into the frozen dessert to give it a thick texture. The amount of the starch composition for food products or emulsion composition blended is as described in “4. Food product” above. Since frozen desserts are served at or lower than body temperature, the above-described starch composition for food products or emulsified composition can be blended to provide high viscosity so that the product has a moderately heavy, dense texture and a rich taste, giving a thick texture when put in the mouth. In addition, as the temperature rises in the mouth, the viscosity weakens, resulting in a pleasant meltability in mouth and a smooth texture. If the frozen dessert contains milk fat or milk solid, the thick texture of the milk is even more apparent. On the other hand, in the case of an ice cream sauce containing fruit juice such as orange juice, a pulpy or puree-like texture is obtained upon eating, followed by a chewy, thick texture as the ice cream sauce gradually melts in the mouth.

### 6. Ice-Crystal Stabilizer

The present invention provides an ice-crystal stabilizer, which comprises the above-described starch composition for food products or emulsified composition as an active ingredient.

The starch composition for food products or the emulsified composition has an effect of stabilizing ice crystals in frozen food products and can inhibit the formation and growth of ice crystals in the frozen food products during frozen storage.

The content of the starch composition for food products or the emulsified composition in the ice-crystal stabilizer is preferably 70% or more by mass, more preferably 80% or more by mass, still more preferably 90% or more by mass, and particularly preferably 95% or more by mass. There is no upper limit to the above content, which should be less than or equal to 100% by mass. In addition, if necessary, the ice-crystal stabilizer may contain an emulsifier, antioxidant, pH adjuster, dispersant, polysaccharide thickener, seasoning, flavoring, and the like which are generally used in the food product industry.

The ice-crystal stabilizer can be blended into a frozen food product by adding it to the ingredient composition during the production of the frozen food product.

By blending the above-mentioned ice-crystal stabilizer into the frozen food product, ice crystals in the frozen food product can be stabilized and ice crystal formation and growth can be inhibited even under unstable temperature conditions where the storage temperatures may rise, such as when the door of a commercial freezer or home freezer is opened and closed, or during dry ice shipping.

More specifically, when the ice-crystal stabilizer is blended into a frozen dessert, it is possible to maintain its smooth texture for a long period of time without causing grainy and coarse feeling even under storage conditions where the freezing temperature is unstable. The ice-crystal stabilizer can also be blended into a frozen dessert to prevent melting and provide excellent shape retention even under unstable temperature conditions.

In addition, the ice-crystal stabilizer can be blended into a frozen processed food product to prevent deterioration of the texture and maintain the original texture for a long period of time, even under storage conditions with unstable freezing temperature.

The ice-crystal stabilizer is blended into the frozen food product in an amount such that the content of the starch composition for food products or emulsified composition is preferably in a range not less than 0.05% and not more than 30% by mass, more preferably in a range not less than 0.1% and not more than 25% by mass, and still more preferably in a range not less than 0.25% and not more than 20% by mass relative to the mass of the ingredient composition of the frozen food product.

### 7. Method for Stabilizing Ice Crystals

The present invention provides a method for stabilizing ice crystals in a frozen food product, the method comprising blending the starch composition for food products or the emulsified composition into the frozen food product.

The starch composition for food products or the emulsified composition described above can be blended into a frozen food product to stabilize the ice crystals contained in the frozen food product. More specifically, growth of ice crystals in the frozen food product can be prevented and the texture of the frozen food product can be maintained for a long period of time in a good state even under unstable temperature conditions where the storage temperatures can rise, such as when the door of a commercial freezer is opened and closed or during dry ice shipping, or even under storage conditions with unstable freezing temperature, such as in a household freezer where the door is frequently opened and closed. In particular, in a case of a frozen dessert, it is possible to maintain its smooth texture for a long period of time without causing grainy and coarse feeling even under storage conditions where the freezing temperature is unstable. In addition, it is possible to prevent melting and provide excellent shape retention even under unstable temperature conditions.

In addition, the ice-crystal stabilizer can be blended into a frozen processed food product to prevent deterioration of the texture and maintain the original texture for a long period of time, even under storage conditions with unstable freezing temperature.

The amount of the starch composition for food products or the emulsified composition blended into the frozen food product is in the same range as that mentioned in “6. Ice-crystal stabilizer” above.

Herein, the “frozen food product” is not particularly limited as long as it is a food product that is preserved in a frozen state, where examples thereof include: frozen desserts such as ice creams, ice milks, lacto ice creams, ice confections, ice cream sauces, frozen cakes, and frozen cream puffs; frozen fish paste products such as frozen kamaboko and frozen hanpen (Japanese fish cakes); and frozen processed food products such as frozen ganmodoki (deep-fried bean curd containing vegetables), frozen hamburger steaks, and frozen gyoza (one kind of Chinese dumplings). The frozen food product is preferably a frozen dessert or frozen fish paste product, and more preferably a frozen dessert.

### EXAMPLES

Hereinafter, the present invention will be described in more detail by way of examples, although the present invention should not be limited in any way to these examples.

### Preparation of Starch Composition for Food Products

Starch compositions for food products of Examples 1 to 5 were prepared using the raw material starches and polyglycerol fatty acid esters shown in Table 1. In Comparative examples 1 and 2, monoglycerol fatty acid esters were used instead of polyglycerol fatty acid esters. In Comparative example 3, raw high-amylose corn starch was used as the raw material starch. Each of the starch compositions for food products was prepared by the following method. Along with Example 1, Examples 1-1, 1-2, and 1-3 were also carried out by varying the outlet temperature. The outlet temperatures for the examples and comparative examples are shown in Table 3.

### Example 1

An ingredient mixture of 2 kg of raw potato starch and 40 g of polyglycerol fatty acid ester (stearic acid) (addition of 2 parts by mass per 100 parts by mass of the raw material starch) was subjected to a heat treatment in a twin-screw extruder (“KEI-45-15” manufactured by Kowa Kogyo Inc.) while adding water for 11.5% by mass relative to the mixture (50 g/min), thereby obtaining a starch composition for food products of Example 1. The conditions for the twin-screw extruder were as follows: barrel temperature 30° C.-170° C., outlet temperature 100° C.-170° C., pressure condition 5 MPa or lower, and screw speed 230 rpm.

### Example 2

An ingredient mixture of 2 kg of distarch phosphate potato starch and 40 g of polyglycerol fatty acid ester (stearic acid) (addition of 2 parts by mass per 100 parts by mass of the raw material starch) was subjected to a heat treatment in a twin-screw extruder while adding water for 11.5% by mass relative to the mixture (50 g/min), thereby obtaining a starch composition for food products of Example 2. The conditions for the twin-screw extruder were as follows: barrel temperature 30° C.-170° C., outlet temperature 100° C.-170° C., pressure condition 5 MPa or lower, and screw speed 230 rpm.

### Example 3

An ingredient mixture of 2 kg of hydroxypropyl distarch phosphate potato starch and 40 g of polyglycerol fatty acid ester (stearic acid) (addition of 2 parts by mass per 100 parts by mass of the raw material starch) was subjected to a heat treatment in a twin-screw extruder while adding water for 11.5% by mass relative to the mixture (50 g/min), thereby obtaining a starch composition for food products of Example 3. The conditions for the twin-screw extruder were as follows: barrel temperature 30° C.-170° C., outlet temperature 100° C.-170° C., pressure condition 5 MPa or lower, and screw speed 230 rpm.

### Example 4

An ingredient mixture of 2 kg of raw potato starch and 40 g of polyglycerol fatty acid ester (behenic acid) (addition of 2 parts by mass per 100 parts by mass of the raw material starch) was subjected to a heat treatment in a twin-screw extruder while adding water for 11.5% by mass relative to the mixture (50 g/min), thereby obtaining a starch composition for food products of Example 4. The conditions for the twin-screw extruder were as follows: barrel temperature 30° C.-170° C., outlet temperature 100° C.-170° C., pressure condition 5 MPa or lower, and screw speed 230 rpm.

### Example 5

An ingredient mixture of 2 kg of hydroxypropyl potato starch and 40 g of polyglycerol fatty acid ester (stearic acid) (addition of 2 parts by mass per 100 parts by mass of the raw material starch) was subjected to a heat treatment in a twin-screw extruder while adding water for 11.5% by mass relative to the mixture (50 g/min), thereby obtaining a starch composition for food products of Example 5. The conditions for the twin-screw extruder were as follows: barrel temperature 30° C.-170° C., outlet temperature 100° C.-170° C., pressure condition 5 MPa or lower, and screw speed 230 rpm.

### Comparative Example 1

An ingredient mixture of 2 kg of raw potato starch and 40 g of monoglycerol fatty acid ester (60% palmitic acid and 40% stearic acid) (addition of 2 parts by mass per 100 parts by mass of the raw material starch) was subjected to a heat treatment in a twin-screw extruder while adding water for 11.5% by mass relative to the mixture (50 g/min), thereby obtaining a starch composition for food products of Comparative example 1. The conditions for the twin-screw extruder were as follows: barrel temperature 30° C.-170° C., outlet temperature 100-165° C., pressure condition 5 MPa or lower, and screw speed 230 rpm.

### Comparative Example 2

An ingredient mixture of 2 kg of distarch phosphate potato starch and 40 g of monoglycerol fatty acid ester (60% palmitic acid and 40% stearic acid) (addition of 2 parts by mass per 100 parts by mass of the raw material starch) was subjected to a heat treatment in a twin-screw extruder while adding water for 11.5% by mass relative to the mixture (50 g/min), thereby obtaining a starch composition for food products of Comparative example 2. The conditions for the twin-screw extruder were as follows: barrel temperature 30° C.-170° C., outlet temperature 100-165° C., pressure condition 5 MPa or lower, and screw speed 230 rpm.

### Comparative Example 3

An ingredient mixture of 2 kg of raw high-amylose cornstarch and 40 g of polyglycerol fatty acid ester (stearic acid) (addition of 2 parts by mass per 100 parts by mass of the raw material starch) was subjected to a heat treatment in a twin-screw extruder while adding water for 11.5% by mass relative to the mixture (50 g/min), thereby obtaining a starch composition for food products of Comparative example 3. The conditions for the twin-screw extruder were as follows: barrel temperature 30° C.-170° C., outlet temperature 100° C.-170° C., pressure condition 5 MPa or lower, and screw speed 230 rpm.

TABLE 1

| | Additives | | | | | Raw material starch | | |
|---|---|---|---|---|---|---|---|---|
| | Type | Fatty acid | Product name, manufacturer | HLB | Degree of polymerization | Type | Modification treatment | Product name, manufacturer |
| Example 1 | Polyglycerol fatty acid ester | Stearic acid + a few percent of palmitic acid | “GRINDSTED PGE 55-M” manufactured by DuPont Specialty Products | About 7 | 3 or less | Potato | Raw | “BP-200” manufactured by J-OIL MILLS |
| Example 2 | | | | | | | Phosphate cross-linking | “KPS-200” manufactured by J-OIL MILLS |
| Example 3 | | | | | | | Hydroxypropylation/P hosphate cross-linking | “EG-500” manufactured by J-OIL MILLS |
| Example 4 | | Behenic acid | “B-100DF” manufactured by Mitsubishi-Chemical Foods Corporation | 3 | 10 | | Raw | “BP-200” manufactured by J-OIL MILLS |
| Example 5 | | Stearic acid + a few percent of palmitic acid | “GRINDSTED PGE 55-M” manufactured by DuPont Specialty Products | About 7 | 3 or less | | Hydroxypropylation | “BO-15” manufactured by J-OIL MILLS |
| Comparative example 1 | Monoglycerol fatty acid ester | 60% Palmitic acid 40% Stearic acid | “POEM P(V)S” manufactured by RIKEN VITAMIN Co., Ltd. | 4-5 | - | | Raw | “BP-200” manufactured by J-OIL MILLS |
| Comparative example 2 | | | | | | | Phosphate cross-linking | “KPS-200” manufactured by J-OIL MILLS |
| Comparative example 3 | Polyglycerol fatty acid ester | Stearic acid + a few percent of palmitic acid | “GRINDSTED PGE 55-M” manufactured by DuPont Specialty Products | About 7 | 3 or less | High-amylose corn starch | Raw | “HS-7” manufactured by J-OIL MILLS |

### 1] Viscosity Characteristics of Slurries (Brookfield Viscosity)

40 g of edible oil/fat (edible rapeseed oil, “Sarasara Canola Oil” manufactured by J-OIL MILLS) and 140 g of water were used per 20 g of starch composition for food products listed in Table 1 (i.e., starch composition for food products: edible oil/fat: water ratio = 1:2:7) to obtain a slurry by mixing the starch composition for food products with the edible oil/fat and allowing to absorb the edible oil/fat, then adding water to the resultant while stirring. When a portion of the slurry (in unheated state) containing the starch composition for food products of Example 1-2 was scooped up, it showed rice cake-like viscoelasticity due to its own viscoelasticity as shown in FIG. 1. Similar physical properties were also observed for Examples 2 to 5. On the other hand, the starch compositions for food products of Comparative examples 1 and 2 completely separated from the edible oil/fat instead of being emulsified, absorbed water to form lumps, and did not exhibit rice cake-like stretch. The starch composition for food products of Comparative example 3 was completely separated with little oil and water absorption, and did not exhibit rice cake-like viscoelasticity.

### <Method for Measuring Brookfield Viscosity>

The slurries obtained in Examples 1, 3, 4, and 5 and Comparative examples 1, 2, and 3 were heated from room temperature (normal temperature) (20° C.) to 90° C. and then cooled from 90° C. to 0° C. according to the conditions for temperature increase and decrease shown in Table 2 below, and the Brookfield viscosity of each slurry at each temperature was measured using a No. 4 rotor for Brookfield viscometer (BM model manufactured by Toki Sangyo Co., Ltd.) under the conditions of 30 rpm for 30 seconds. For the slurry obtained in Example 5, a polypropylene cylinder with a diameter of 7 cm and a height of 9.5 cm (250 ml container manufactured by Kartell) was used for the measurement of the slurry under the conditions for temperature decrease. When heating the slurry, the container was covered with plastic wrap to prevent evaporation of moisture, and the measurement was performed immediately after reaching the specified temperature. For Example 2, texture evaluation is shown.

TABLE 2

Conditions for temperature increase

| | Room temperature | 20° C. |
|---|---|---|
| Place in 80° C. hot water bath | | 30° C. |
| | | 40° C. |
| | | 50° C. |
| | | 60° C. |
| Warm in microwave oven | 500 W 30 seconds | 70° C. |
| | 700 W 20 seconds | 80° C. |
| | 700 W 30 seconds | 90° C. |
| Conditions for temperature decrease | | |
| Warm in microwave oven | 700 W 60 seconds or longer | 90° C. |
| Cool at room temperature or in ice water | | 80° C. |
| | | 70° C. |
| | | 60° C. |
| | | 50° C. |
| | | 40° C. |
| | | 30° C. |
| | | 20° C. |
| | | 10° C. |
| Place in freezer | | 5° C. |
| | | 0° C. |

The results of the examples are shown in Table 3. The results of the comparative examples are also shown in Table 4.

TABLE 3

(Pa•s)

| Composition of raw ingredients | | | Example 1-1 | Example 1-2 | Example 1-3 | Example 2 | Example 3 | Example 4 | Example 5 |
|---|---|---|---|---|---|---|---|---|---|
| Outlet temperature of extruder | | | 110° C. | 130° C. | 160° C. | 142° C. | 144° C. | 157° C. | 150° C. |
| Brookfield viscosity [Pa•s] | During preparation | 20° C. | 6.9 | 5.2 | 9.1 | It had rice cake-like viscoelasticity at 20° C., low viscosity at high temperatures, and high viscosity at low temperatures. | 80.5 | 3.8 | Not measured |
| | During temperature increase | 30° C. | 4.6 | 3.7 | 6.0 | | 56.5 | 2.9 | |
| | | 40° C. | 3.2 | 2.8 | 3.6 | | 39 | 2.7 | |
| | | 50° C. | 2.6 | 2.1 | 3.4 | | 20 | 2.2 | |
| | | 60° C. | 2.6 | 2.0 | 2.9 | | 12.5 | 1.8 | |
| | | 70° C. | 2.1 | 1.5 | 2.3 | | 6 | 1.3 | |
| | | 80° C. | 1.6 | 1.3 | 1.8 | | 4 | 0.8 | |
| | | 90° C. | 1.6 | 1.4 | 1.7 | | 3.5 | 0.4 | 0.5 |
| | During temperature decrease | 90° C. | 1.1 | 1.3 | 1.3 | | 4.5 | 0.6 | 0.5 |
| | | 80° C. | 1.3 | 1.5 | 1.6 | | 6.5 | 0.8 | 0.6 |
| | | 70° C. | 2.2 | 1.7 | 2.7 | | 6.75 | 1 | 0.6 |
| | | 60° C. | 2.5 | 1.9 | 2.7 | | 9.5 | 1.7 | 0.7 |
| | | 50° C. | 2.9 | 2.3 | 3.0 | | 16.5 | 2.2 | 0.8 |
| | | 40° C. | 4.0 | 2.6 | 3.8 | | 17.5 | 2.9 | 1.7 |
| | | 30° C. | 4.8 | 3.6 | 4.8 | | 22 | 3.8 | 2 |
| | | 20° C. | 5.3 | 4.8 | 5.9 | | 29.75 | 4.1 | 2.9 |
| | | 10° C. | 6.6 | 5.2 | 6.8 | | 42.75 | 4.44 | 4.2 |
| | | 5° C. | - | 5.6 | - | | 49 | - | 4.8 |
| | | 0° C. | 10.3 | 7.3 | 12.0 | | 52 | 6.16 | 6.6 |

TABLE 4

| Composition of raw ingredients | | | Comparative example 1 | Comparative example 2 | Comparative example 3 |
|---|---|---|---|---|---|
| Outlet temperature of extruder | | | 130° C. | 169° C. | 131° C. |
| Brookfield viscosity [Pa•s] | During preparation | 20° C. | 0.4 | 0.4 | 0.015 |
| | During temperature increase | 30° C. | 0.4 | 0.5 | 0.02 |
| | | 40° C. | 0.5 | 0.3 | 0 |
| | | 50° C. | 0.4 | 0.56 | 0.01 |
| | | 60° C. | 0.8 | 0.56 | 0.015 |
| | | 70° C. | 6.3 | 2.16 | 0.015 |
| | | 80° C. | 4.1 | 3.4 | 0.05 |
| | | 90° C. | 8.5 | 6.04 | 0.035 |
| | During temperature decrease | 90° C. | 9.3 | 5.4 | 0.095 |
| | | 80° C. | 8.5 | 5.5 | 0.1 |
| | | 70° C. | 9.2 | 5.1 | 0.12 |
| | | 60° C. | 13.9 | 4.4 | 0.12 |
| | | 50° C. | 13.2 | 5.2 | 0.18 |
| | | 40° C. | 14.0 | 5.44 | 0.23 |
| | | 30° C. | 14.0 | 6.12 | 0.28 |
| | | 20° C. | 15.0 | 7.64 | 0.70 |
| | | 10° C. | 13.3 | 6.3 | 1.1 |
| | | 5° C. | 35.1 | 6.1 | 2.8 |
| | | 0° C. | 30.0 | 7.6 | 1.6 |

Starch compositions for food products were prepared by varying the amount of polyglycerol fatty acid ester added per 100 parts by mass of the raw material starch in the composition of the raw ingredients in Example 1 (outlet temperature of extruder: 130° C.). 20 g of each of the starch compositions for food products was mixed with and allowed to absorb 40 g of edible oil/fat (that was twice as much as the amount of the starch composition for food products). Then, 80 g of water (that was 4 times as much as the amount of the starch composition for food products) was added to the resultant, and the mixture was stirred until it became sticky to obtain a slurry. Table 5 shows the results of texture evaluation of each slurry by stirring it with a spoon to evaluate the physical property, i.e., rice cake-like stretch.

TABLE 5

| Amount of polyglycerol fatty acid ester added [Parts by mass] | Results of texture evaluation |
|---|---|
| 0 | Control |
| 0.5 | Well emulsified. Stretch was comparable to that of the control. Viscosity was low. |
| 0.8 | Well emulsified. Stretch was comparable to that of the control. Viscosity was low. |
| 1.0 | Well emulsified. More stretchy and viscous than the control. |
| 1.5 | Well emulsified. More stretchy and viscous than the control. |
| 2.0 | Well emulsified. More stretchy and viscous than the control. |
| 3.0 | Well emulsified. More stretchy and viscous than the control. |
| 5.0 | Did not stretch. |
| 10.0 | Did not stretch. |

As shown in these results, the slurries containing the starch composition for food products of the present invention, an edible oil/fat that was twice as much and water that was 7 times as much as the amount of the starch composition for food products had a rice cake-like viscoelasticity and as shown in Table 3, the slurries had the desired Brookfield viscosity (Pa•s) in unheated state (20° C.) after preparation, and exhibited the viscosity characteristics defined by “the Brookfield viscosity (Pa•s) at 0° C. is not less than twice and not more than 30 times the Brookfield viscosity at 90° C.”.

On the other hand, in Comparative examples 1 and 2, emulsified slurry was not obtained because the oil/fat phase separated, and rice cake-like viscoelasticity was not obtained. The Brookfield viscosity (Pa•s) in unheated state (20° C.) was also not in the desired range. Moreover, in Comparative example 3, emulsified slurry was not obtained and the Brookfield viscosity (Pa•s) in unheated state (20° C.) was not in the desired range.

Starch compositions for food products were prepared by varying the amount of polyglycerol fatty acid ester added per 100 parts by mass of the raw material starch in the composition of the raw ingredients in Example 1 (outlet temperature of extruder: 130° C.). The amount of starch-lipid complexes formed in each of the starch compositions for food products was determined according to the following method based on the difference between the polyglycerol fatty acid ester contained in the raw ingredients and the polyglycerol fatty acid ester remaining in the starch composition for food products.

### <Method for Determining Amount of Starch-Lipid Complex Formed in Starch Composition for Food Products>

A differential scanning calorimeter (“DSC 7000-X” manufactured by Hitachi, Ltd.) was used, and 2 mg of each starch composition for food products and 9.5 mg of water were put in a low-pressure sealed chromated Al sample pan with cover and sealed. This was left at room temperature (25° C.) for at least 3 hours to allow water absorption.

A blank cell was used as reference. The temperature was increased from 10° C. to 140° C. at a rate of 3° C./min (measurement point: every 0.5 seconds).

For the obtained DSC chart, the amount of heat measured from the endothermic peak area having a peak top in the temperature range of 45-80° C. was defined as the enthalpy of the remaining polyglycerol fatty acid ester per unit dry mass.

Based on the enthalpy of the remaining polyglycerol fatty acid ester obtained above and the amount of the polyglycerol fatty acid ester added in each composition, the amount of starch-lipid complex formed was calculated using the following procedure. Specifically, it was calculated as follows.
(i) First, the enthalpy of the remaining polyglycerol fatty acid ester alone (100 mass%) was determined.
(ii) The enthalpy of the remaining polyglycerol fatty acid esters obtained in (i) above was multiplied by the content of the polyglycerol fatty acid esters in the raw ingredients of the starch composition for food products (e.g., 0.02 in case of 2 mass%) to calculate the enthalpy of the remaining polyglycerol fatty acid ester with respect to the content of the polyglycerol fatty acid ester in the raw ingredients (i.e., enthalpy of the remaining polyglycerol fatty acid ester for 2 mass%).
(iii) The enthalpy of the remaining polyglycerol fatty acid ester obtained above using the starch composition for food products as the sample was divided by the enthalpy of the remaining polyglycerol fatty acid ester with respect to the content of the polyglycerol fatty acid ester in the raw ingredients (enthalpy of the remaining polyglycerol fatty acid ester for 2 mass%) and the resultant was multiplied by the content of the polyglycerol fatty acid ester contained in the raw ingredients (0.02 if the amount added was 2 mass%) to obtain the amount (%) of the remaining polyglycerol fatty acid ester in the starch composition for food products.
(iv) Finally, the amount (%) of the remaining polyglycerol fatty acid ester determined in (iii) above was subtracted from the amount of the polyglycerol fatty acid ester contained in the raw ingredients (e.g., 2% if the added amount was 2 mass%), thereby determining the amount of starch-lipid complex formed (%).

Results are shown in Table 5A.

TABLE 5A

| | | | | | | | |
|---|---|---|---|---|---|---|---|
| Polyglycerol fatty acid ester content in raw ingredients (mass%) | 0% | 0.5% | 0.8% | 1.0% | 1.5% | 2.0% | 3.0% |
| Starch-lipid complex content (mass%) in starch composition for food products | - | 0.3% | 0.5% | 0.5% | 0.5% | 0.8% | 1.3% |

[2-2] Viscosity characteristics (Brookfield viscosity) of slurries 20 g of the starch composition for food products prepared under the conditions of Example 1-2 was mixed with and allowed to absorb 40 g of edible oil/fat (that was twice as much as the amount of the starch composition for food products) listed in Table 5B, and then 80 g of water (that was 4 times as much as the amount of the starch composition for food products) was added to the mixture and stirred until it became sticky to obtain a slurry (Examples 1-4 to 1-7). Table 5B shows the results of texture evaluation of each slurry by stirring it with a spoon to evaluate the physical property, i.e., rice cake-like stretch.

TABLE 5B

| | | | |
|---|---|---|---|
| | Type of oil | | Physical properties of slurry (in unheated state) |
| Example 1-4 | Olive oil | “AJINOMOTO Extra Virgin Olive Oil” manufactured by J-OIL MILLS | Emulsified and exhibited rice cake-like stretch |
| Example 1-5 | Coconut oil | “Refined coconut oil” manufactured by Fuji Oil Co., Ltd. | Emulsified and exhibited rice cake-like stretch Firm but smooth dough |
| Example 1-6 | Corn oil | “AJINOMOTO Corn Oil” manufactured by J-OIL MILLS | Emulsified and exhibited rice cake-like stretch Firm but smooth dough |
| Example 1-7 | Rice bran oil | “AJINOMOTO Rice Bran Oil” manufactured by J-OIL MILLS | Emulsified and exhibited rice cake-like stretch Firm but smooth dough |

As shown in Table 5B, the properties of the slurries did not change depending on the type of oil.

### <Method for Measuring Brookfield Viscosity>

The slurries obtained in Examples 1-4, 1-5, 1-6, and 1-7 were heated from room temperature (20° C.) to 90° C. and then cooled from 90° C. to 0° C. according to the conditions for temperature increase and decrease shown in Table 2, and the Brookfield viscosity of each slurry at each temperature was measured using a No. 4 rotor for Brookfield viscometer (BM model manufactured by Toki Sangyo Co., Ltd.) under the conditions of 30 rpm for 30 seconds. A polypropylene cylinder with a diameter of 7 cm and a height of 9.5 cm (250 ml container manufactured by Kartell) was used for the measurement. When heating the slurry, the container was covered with plastic wrap to prevent evaporation of moisture, and the measurement was performed immediately after reaching the specified temperature. Results are shown in Table 5C.

TABLE 5C

(Pa•s)

| Composition of raw ingredients | | | Example 1-4 | Example 1-5 | Example 1-6 | Example 1-7 |
|---|---|---|---|---|---|---|
| Outlet temperature of extruder | | | 130° C. | 130° C. | 130° C. | 130° C. |
| Brookfield viscosity [Pa·s] | During preparation | 20° C. | 8.36 | 7.68 | 7.5 | 7.02 |
| | During temperature increase | 30° C. | 5.06 | 4.8 | 4.8 | 6.88 |
| | | 40° C. | 3.4 | 3.6 | 3.6 | 5.1 |
| | | 50° C. | 2.9 | 3 | 2.4 | 3.2 |
| | | 60° C. | 2.4 | 2.6 | 2.4 | 2.7 |
| | | 70° C. | 2.3 | 2.2 | 2.3 | 2.5 |
| | | 80° C. | 2.2 | 1.9 | 2 | 2 |
| | | 90° C. | 2 | 1.2 | 1.6 | 1.8 |
| | During temperature decrease | 90° C. | 1.6 | 1.2 | 1.5 | 1.9 |
| | | 80° C. | 2.4 | 1.4 | 1.8 | 1.9 |
| | | 70° C. | 2.5 | 1.8 | 2 | 2.7 |
| | | 60° C. | 2.4 | 2.3 | 2.4 | 2.4 |
| | | 50° C. | 3.2 | 2.7 | 2.8 | 3.2 |
| | | 40° C. | 3.1 | 3.4 | 3.4 | 3.8 |
| | | 30° C. | 3.5 | 4.6 | 5 | 5.7 |
| | | 20° C. | 4.7 | 5.6 | 5.4 | 5.6 |
| | | 10° C. | 5.4 | 9.2 | 8 | 8.6 |
| | | 5° C. | 8.2 | 14.6 | 9.4 | 12.7 |
| | | 0° C. | 12.4 | 32.25 | 17.4 | 28.25 |

As shown in the above results, there was no significant change in the Brookfield viscosity characteristics when the type of oil was changed. The slurry containing the starch composition for food products of the present invention, an edible oil/fat that was twice as much and water that was 7 times as much as the amount of the starch composition for food products had a rice cake-like viscoelasticity and as shown in Table 5C, the slurry had the desired Brookfield viscosity (Pa•s) in unheated state (20° C.) after preparation, and exhibited the viscosity characteristics defined by “the Brookfield viscosity (Pa•s) at 0° C. is not less than twice and not more than 30 times the Brookfield viscosity at 90° C.”. Although there was a slight difference in the Brookfield viscosity at 90° C. when the temperature was increased and when the temperature was decreased, it is sufficient if, according to the present invention, the Brookfield viscosity of the slurry that reached 90° C. for the first time after its preparation (i.e., the Brookfield viscosity at 90° C. when the temperature was increased) met the above conditions.

### 1] Resistance of Emulsified Compositions Against Freeze-Thaw Cycles

20 g of the starch composition for food products obtained in Example 1-2 was mixed with and allowed to absorb 40 g of edible oil/fat (that was twice as much as the amount of the starch composition for food products), and then 140 g of water (that was 7 times the amount of the starch composition for food products) was added to the mixture and stirred until it became sticky to obtain a slurry. The slurry was subjected to three freeze-thaw cycles shown below, and changes in viscosity characteristics were observed.

TABLE 6

<Freeze-thaw cycles>

| | | | |
|---|---|---|---|
| ^{∗}First freeze-thaw cycle | Place in freezer | Freeze overnight (24 hours) | |
| | ↓ | | |
| | Warm in microwave oven | 700 W, 1 minute or longer | 60° C. |
| | Cool at room temperature or in ice water | | 50° C. |
| | | | 40° C. |
| | | | 30° C. |
| | | | 20° C. |
| | | | 10° C. |
| | | | 5° C. |
| | | | 0° C. |
| ^{∗}Second freeze-thaw cycle Freezer storage leads to dehydration, but freeze-thaw is continued | Place in freezer | Freeze overnight (24 hours) | |
| | ↓ | | |
| | Warm in microwave oven | 700 W, 1 minute or longer | 60° C. |
| | Cool at room temperature or in ice water | | 50° C. |
| | | | 40° C. |
| | | | 30° C. |
| | | | 20° C. |
| | | | 10° C. |
| | | | 5° C. |
| | | | 0° C. |
| ^{∗}Third freeze-thaw cycle Freezer storage leads to dehydration, but freeze-thaw is continued | Place in freezer | Freeze overnight (48 hours) | |
| | ↓ | | |
| | Warm in microwave oven | 700 W, 1 minute or longer | 60° C. |
| | Cool at room temperature or in ice water | | 50° C. |
| | | | 40° C. |
| | | | 30° C. |
| | | | 20° C. |
| | | | 10° C. |
| | | | 5° C. |
| | | | 0° C. |

The above freeze-thaw cycles meet the following conditions.
“<Conditions for freeze-thaw cycles>
for the first cycle, the slurry prepared at room temperature is cooled to -10° C. at a cooling rate of -1° C./min and kept in that state for at least 15 hours, then the slurry is heated to reach 60° C. at a heating rate of 45° C./min, and then cooled again to -10° C. at a cooling rate of -1° C./min and kept in that state for at least 15 hours; and
for the second cycle and on, the slurry that went through the first cycle is heated to reach 60° C. at a heating rate of 45° C./min and then cooled again to -10° C. at a cooling rate of -1° C./min and kept in that state for at least 15 hours.”

Results are shown in Table 7 and FIGS. 2 and 3.

TABLE 7

(Pa•s)

| °C | During temperature increase | During temperature decrease | First freeze-thaw cycle | Second freeze-thaw cycle | Third freeze-thaw cycle |
|---|---|---|---|---|---|
| 0 | | 7.30 | 8.00 | 16.00 | 17.86 |
| 5 | | 5.56 | 6.46 | 13.60 | 15.18 |
| 10 | | 5.18 | 5.28 | 6.52 | 9.02 |
| 20 | 5.24 | 4.76 | 4.42 | 4.98 | 5.74 |
| 30 | 3.70 | 3.56 | 3.08 | 4.04 | 4.56 |
| 40 | 2.76 | 2.64 | 2.50 | 3.12 | 4.46 |
| 50 | 2.12 | 2.28 | 1.98 | 2.36 | 3.16 |
| 60 | 1.98 | 1.88 | 1.54 | 1.80 | 2.52 |
| 70 | 1.48 | 1.74 | | | |
| 80 | 1.32 | 1.48 | | | |
| 90 | 1.36 | 1.26 | | | |

FIG. 2 is a graph showing changes in the viscosity characteristics during the three freeze-thaw cycles.

FIG. 3 shows photographs that represent the property of each slurry at 20° C. during (a) the first freeze-thaw cycle, (b) the second freeze-thaw cycle, and (c) the third freeze-thaw cycle.

As shown in Table 7 and FIGS. 2 and 3, a slurry containing the starch composition for food products of the present invention, an edible oil/fat that was twice as much as the amount the starch composition for food products, and water that was 7 times as much as the amount of the starch composition for food products showed little change in the viscosity characteristics after three freeze-thaw cycles, indicating that the slurry was resistant against freeze-thawing.

### 2] Resistance of Emulsified Compositions Against Freeze-Thaw Cycles

20 g of the starch composition for food products obtained in Example 3 was mixed with and allowed to absorb 40 g of edible oil/fat (that was twice as much as the amount of the starch composition for food products), and then 140 g of water (that was 7 times the amount of the starch composition for food products) was added to the mixture and stirred until it became sticky to obtain a slurry. The slurry was subjected to three freeze-thaw cycles shown in Table 6, and changes in viscosity characteristics were observed. Note that, in each freeze-thaw cycle, the slurry was warmed in a microwave oven after water was added to compensate the loss of water caused by storing the slurry in the freezer.

Results are shown in Table 7A and FIGS. 4 and 5.

TABLE 7A

(Pa•s)

| °C | During temperature decrease | First freeze-thaw cycle | Second freeze-thaw cycle | Third freeze-thaw cycle |
|---|---|---|---|---|
| 0 | 45.35 | 36 | 31 | 31.75 |
| 5 | 36 | 19.6 | 17.2 | 18 |
| 10 | 19.4 | 18.3 | 16.8 | 13.7 |
| 20 | 16.5 | 13.8 | 12.1 | 11.4 |
| 30 | 16.4 | 13.6 | 11.2 | 10.8 |
| 40 | 14 | 12.4 | 10 | 9.4 |
| 50 | 10.8 | 10 | 7.2 | 8.2 |
| 60 | 5.4 | 6 | 4.4 | 6.6 |
| 70 | 3.6 | | | |
| 80 | 2.8 | | | |
| 90 | 2.6 | | | |

FIG. 4 is a graph showing changes in the viscosity characteristics during the three freeze-thaw cycles.

FIG. 5 shows photographs that represent the property of each slurry at 20° C. during (a) the first freeze-thaw cycle, (b) the second freeze-thaw cycle, and (c) the third freeze-thaw cycle.

### 3] Resistance of Emulsified Compositions Against Freeze-Thaw Cycles

20 g of the starch composition for food products obtained in Example 5 was mixed with and allowed to absorb 40 g of edible oil/fat (that was twice as much as the amount of the starch composition for food products), and then 140 g of water (that was 7 times the amount of the starch composition for food products) was added to the mixture and stirred until it became sticky to obtain a slurry. The slurry was subjected to three freeze-thaw cycles shown in Table 6, and changes in viscosity characteristics were observed. Note that, in each freeze-thaw cycle, the slurry was warmed in a microwave oven after water was added to compensate the loss of water caused by storing the slurry in the freezer.

Results are shown in Table 7B and FIGS. 6 and 7.

TABLE 7B

(Pa·s)

| °C | During temperature decrease | First freeze-thaw cycle | Second freeze-thaw cycle | Third freeze-thaw cycle |
|---|---|---|---|---|
| 0 | 6.64 | 6 | 5.7 | 6 |
| 5 | 4.8 | 4.8 | 4 | 3.5 |
| 10 | 4.2 | 3.6 | 3.5 | 2.6 |
| 20 | 2.9 | 2.3 | 2.4 | 1.6 |
| 30 | 2 | 1.6 | 1.6 | 1.4 |
| 40 | 1.7 | 1.4 | 1.2 | 1 |
| 50 | 0.8 | 1 | 0.9 | 0.7 |
| 60 | 0.7 | 0.6 | 0.7 | 0.6 |
| 70 | 0.64 | | | |
| 80 | 0.6 | | | |
| 90 | 0.46 | | | |

FIG. 6 is a graph showing changes in the viscosity characteristics during the three freeze-thaw cycles.

FIG. 7 shows photographs that represent the property of each slurry at 20° C. during (a) the first freeze-thaw cycle, (b) the second freeze-thaw cycle, and (c) the third freeze-thaw cycle.

### Ice Cream Sauce (Orange)

Ice cream sauces (orange) were prepared according to the following method using the compositions shown in Table 8, and their textures were evaluated by five expert panelists. As reference examples, the difference in the textures from an ice cream sauce made from frozen orange juice only and from an ice cream sauce blended with a commercially available thickening stabilizer were also evaluated. Results are shown in Table 8.

### <Method for Preparing Ice Cream Sauce>

1. Using the starch composition for food products, canola oil, and orange juice (indicated as “juice” in the table) in a quantity ratio of 1 (5 g):1-2:7-9 (starch composition for food products: canola oil: orange juice), the starch composition for food products was first dispersed in canola oil while stirring, and then orange juice was added to the mixture while stirring at room temperature. When canola oil was not added, each ingredient and orange juice were blended in a quantity ratio of 1:9 (ingredient: orange juice) and the mixture was heated in a boiling water bath for dispersion.

2. The mixture obtained in 1. was poured into a plastic cup, which was then placed in the freezer to chill and harden, thereby obtaining an ice cream sauce.

3. The ice cream sauces were taken out of the freezer at the same time to compare their textures.

TABLE 8

| | Reference example 2-1 | Example 2-1 | Example 2-2 | Example 2-3 | Reference example 2-2 | Example 2-4 |
|---|---|---|---|---|---|---|
| | Fruit juice only | Starch composition for food products: Oil: Fruit juice = 1 (5 g):2 (10 g):7 (35 g) | Starch composition for food products: Oil: Fruit juice = 1 (5 g):2 (10 g):8 (40 g) | Starch composition for food products: Oil: Fruit juice = 1 (5 g):1 (5 g):9 (45 g) | Thickening stabilizer: Fruit juice =1 (5 g):9 (45 g) | Starch composition for food products: Fruit juice = 1 (5 g):9 (45 g) |
| Workability | | Dispersed in unheated state | Dispersed in unheated state | Dispersed in unheated state | Lumps were formed in unheated state, but the ingredient was dispersed and the mixture became viscous when heated in a hot water bath at 85° C. | Lumps were formed in cold water, but the ingredient was dispersed when heated in a hot water bath at 85° C. Viscosity weakened and the mixture did not stretch but it became viscous when cooled. |
| Texture evaluation after freezing | Ice; grainy; Sherbet | Rice cake-like; Melted surface stretched a little | Mild; Surface stretched a little; Ice had frosty texture, but melted and became dense at oral temperature | Mild; Surface stretched a little; Ice had frosty texture, but melted and became dense at oral temperature | Mild; Surface stretched a little; Ice had frosty texture, but melted and became dense at oral temperature with strong sour taste; Color was dark | Mild; Surface stretched a little; Ice had frosty texture, but melted and became dense at oral temperature; Pulpiness/puree texture; Sour taste was milder than Reference example 2; Color was dark |

The following ingredients were used for the ice cream sauces (orange).
Starch composition for food products: Starch composition for food products obtained in Example 1-2
Orange Juice: “Tropicana 100% Orange Juice” manufactured by Kirin Beverage Company, Limited (orange (Valencia), vitamin C (125-782 mg), flavoring)
Canola oil: Edible rapeseed oil “Sarasara Canola Oil” manufactured by J-OIL MILLS
Thickening stabilizer formulation: “Nobiemon” manufactured by Mitsubishi Corporation Life Sciences Limited, 32% hydroxypropyl starch, 13% acetylated distarch adipate, 10% curdlan, 0.1% guar gum, and 44.9% food ingredients

### Ice Cream Sauce (Milk)

Ice cream sauces (milk) were prepared according to the following method using the compositions shown in Table 9, and their textures were evaluated by five expert panelists. As reference examples, the difference in the textures from an ice cream sauce made from frozen cow’s milk only and from an ice cream sauce blended with a commercially available thickening stabilizer was also evaluated. Results are shown in Table 9.

### <Method for Preparing Ice Cream Sauce>

1. Using the starch composition for food products, canola oil, and cow’s milk in a quantity ratio of 1 (5 g):1:9 (starch composition for food products: canola oil: cow’s milk), the starch composition for food products was first dispersed in canola oil while stirring, and then cow’s milk was added to the mixture while stirring at room temperature. When canola oil was not added, each ingredient and cow’s milk were blended in a quantity ratio of 1:9 (ingredient: cow’s milk) and the mixture was heated in a boiling water bath for dispersion.

2. The mixture obtained in 1. was poured into a plastic cup, which was then placed in the freezer to chill and harden, thereby obtaining an ice cream sauce.

3. The ice cream sauces were taken out of the freezer at the same time to compare their textures.

TABLE 9

| | Reference example 3-1 | Example 3-1 | Example 3-2 | Reference example 3-2 |
|---|---|---|---|---|
| | Cow’s milk only | Starch composition for food products: Cow’s milk = 1 (5 g):9 (45 g) | Starch composition for food products: Oil: Cow’s milk = 1 (5 g):1 (5 g):9 (45 g) | Thickening stabilizer: Cow’s milk =1 (5 g):9 (45 g) |
| Workability | | Dispersed by heating but slightly lumpy | Dispersed in unheated state | Lumps were formed in unheated state, but the ingredient was dispersed and the mixture became viscous when heated in a hot water bath at 85° C. |
| Texture evaluation after freezing | Frosty texture; easy to melt | Chewy with stretchy surface; rich flavor; milky taste is easily sensed | Chewy with stretchy surface; pleasant meltability in mouth, light texture without oiliness, and yet has a thick, rich taste; persistent milkiness in the aftertaste. | Chewy with stretchy surface; light texture and not rich |

The following ingredients were used for the ice cream sauces (milk).
Starch composition for food products: Starch composition for food products obtained in Example 1-2
Cow’s milk: “Bokujo-umare-no-gyunyu” manufactured by Gunma prefecture milk producers’ cooperative union
Canola oil: Edible rapeseed oil “Sarasara Canola Oil” manufactured by J-OIL MILLS
Thickening stabilizer formulation: “Nobiemon” manufactured by Mitsubishi Corporation Life Sciences Limited, 32% hydroxypropyl starch, 13% acetylated distarch adipate, 10% curdlan, 0.1% guar gum, and 44.9% food ingredients

### Lacto Ice Cream

Lacto ice creams were prepared according to the following method using the compositions shown in Table 10, and five expert panelists evaluated the texture of the ice creams in comparison with control cases without the starch composition for food products of the present invention. Results are shown in Table 10.

### <Method for Preparing Lacto Ice Cream>

1. Refined coconut oil, dextrin, a stabilizer (polysaccharide thickener), and the starch composition for food products were mixed well using a whisk.

2. Granulated sugar dissolved in water, an emulsifier, and skimmed milk powder were mixed using a whisk, and the mixture was heated to 60° C. using a thermostatic water bath.

3. After reaching 50° C., the mixture was emulsified while blending the mixture obtained in 1. using stirrer T.K. HOMOGENIZING DISPER (T.K. HOMO MIXER MARK II manufactured by Tokushu Kika Kogyo Co., Ltd.) at 5000-5500 rpm for 5 minutes.

4. The saucepan was adjusted to zero and the mixture was heated to 85° C. for sterilization (3 minutes at medium flame level 3).

5. The mixture was cooled in ice water, to which water was added to compensate the loss of the evaporated water.

6. After reaching 15° C., the mixture was set in an ice cream maker (CUISINART COMMERCIAL QUALITY ICE CREAM & GELATO MAKER “ICE-100” manufactured by Cuisinart) to be frozen while stirring for 30 minutes to obtain a lacto ice cream.

7. The resulting lacto ice cream was transferred into a container and frozen in the freezer for a while.

8. The lacto ice creams were taken out of the freezer at the same time to compare their textures.

TABLE 10

| | Control case 4-1 | | Control case 4-2 | | Example 4-1 | | Example 4-2 | | Example 4-3 | | Example 4-4 | |
|---|---|---|---|---|---|---|---|---|---|---|---|---|
| Ingredients | Percentage (%) | Mass (g) | Percentage (%) | Mass (g) | Percentage (%) | Mass (g) | Percentage (%) | Mass (g) | Percentage (%) | Mass (g) | Percentage (%) | Mass (g) |
| Water | 62.8% | 375.0 | 63.1% | 375.0 | 63.1% | 375.0 | 62.8% | 375.0 | 62.8% | 375.0 | 61.9% | 375.0 |
| Skimmed milk powder | 9.0% | 54.0 | 9.1% | 54.0 | 9.1% | 54.0 | 9.0% | 54.0 | 9.0% | 54.0 | 8.9% | 54.0 |
| Refined coconut oil | 13.1% | 78.0 | 13.1% | 78.0 | 13.1% | 78.0 | 13.1% | 78.0 | 13.1% | 78.0 | 12.9% | 78.0 |
| Olive oil | 0.0% | 0.0 | 0.0% | 0.0 | 0.0% | 0.0 | 0.0% | 0.0 | 0.0% | 0.0 | 0.0% | 0.0 |
| Granulated sugar | 13.6% | 81.0 | 13.6% | 81.0 | 13.6% | 81.0 | 13.6% | 81.0 | 13.6% | 81.0 | 13.4% | 81.0 |
| Egg yolk | 0.0% | 0.0 | 0.0% | 0.0 | 0.0% | 0.0 | 0.0% | 0.0 | 0.0% | 0.0 | 0.0% | 0.0 |
| Stabilizer (polysaccharide thickener) | 0.25% | 1.5 | 0.00% | 0.0 | 0.0% | 0.0 | 0.25% | 1.5 | 0.0% | 0.0 | 0.0% | 0.0 |
| Emulsifier | 0.25% | 1.5 | 0.00% | 0.0 | 0.0% | 0.0 | 0.0% | 0.0 | 0.25% | 1.5 | 0.0% | 0.0 |
| Starch composition for food products (Example 1-2) | 0.00% | 0.0 | 0.00% | 0.0 | 1.0% | 6.0 | 0.25% | 1.5 | 0.25% | 1.5 | 3.0% | 18.0 |
| Starch composition for food products (Example 5) | 0.0% | 0.0 | 0.0% | 0.0 | 0.0% | 0.0 | 0.0% | 0.0 | 0.0% | 0.0 | 0.0% | 0.0 |
| Dextrin | 1.0% | 6.0 | 1.01% | 6.0 | 0.0% | 0.0 | 1.0% | 6.0 | 1.0% | 6.0 | 0.0% | 0.0 |
| Total | 100.0% | 597.0 | 100.0% | 594.0 | 100.0% | 594.0 | 100.0% | 597.0 | 100.0% | 597.0 | 100.0% | 606.0 |
| Texture evaluation | - | | Rough | | Comparable to Control case 4-1 | | Smooth | | A little ice crystals, rough | | Smooth, dense, thick, and a little stretchy (like Turkish ice cream) | |

TABLE 10 (cont.)

| | Control case 4-1 | | Control case 4-2 | | Example 4-5 | | Example 4-6 | | Example 4-7 | |
|---|---|---|---|---|---|---|---|---|---|---|
| Ingredients | Percentage (%) | Mass (g) | Percentage (%) | Mass (g) | Percentage (%) | Mass (g) | Percentage (%) | Mass (g) | Percentage (%) | Mass (g) |
| Water | 62.8% | 375.0 | 63.1% | 375.0 | 61.9% | 375.0 | 58.7% | 375.0 | 61.9% | 375.0 |
| Skimmed milk powder | 9.0% | 54.0 | 9.1% | 54.0 | 8.9% | 54.0 | 8.5% | 54.0 | 8.9% | 54.0 |
| Refined coconut oil | 13.1% | 78.0 | 13.1% | 78.0 | 6.4% | 39.0 | 12.2% | 78.0 | 12.9% | 78.0 |
| Olive oil | 0.0% | 0.0 | 0.0% | 0.0 | 6.4% | 39.0 | 0.0% | 0.0 | 0.0% | 0.0 |
| Granulated sugar | 13.6% | 81.0 | 13.6% | 81.0 | 13.4% | 81.0 | 12.7% | 81.0 | 13.4% | 81.0 |
| Egg yolk | 0.0% | 0.0 | 0.0% | 0.0 | 0.0% | 0.0 | 1.4% | 9.0 | 0.0% | 0.0 |
| Stabilizer (polysaccharide thickener) | 0.25% | 1.5 | 0.00% | 0.0 | 0.0% | 0.0 | 0.0% | 0.0 | 0.0% | 0.0 |
| Emulsifier | 0.25% | 1.5 | 0.00% | 0.0 | 0.0% | 0.0 | 0.0% | 0.0 | 0.0% | 0.0 |
| Starch composition for food products (Example 1-2) | 0.00% | 0.0 | 0.00% | 0.0 | 3.0% | 18.0 | 6.6% | 42.0 | 0.0% | 0.0 |
| Starch composition for food products (Example 5) | 0.0% | 0.0 | 0.0% | 0.0 | 0.0% | 0.0 | 0.0% | 0.0 | 2.0% | 12.0 |
| Dextrin | 1.0% | 6.0 | 1.01% | 6.0 | 0.0% | 0.0 | 0.0% | 0.0 | 1.0% | 6.0 |
| Total | 100.0% | 597.0 | 100.0% | 594.0 | 100.0% | 606.0 | 100.0% | 639.0 | 100.0% | 606.0 |
| Texture evaluation | - | | Rough | | Smooth, dense, thick, and a little stretchy (like Turkish ice cream) Strong olive flavor | | Smooth, denser than Example 4-4, thick, glutinous texture, stretchy (like Turkish ice cream) | | Smooth, dense, thick, and very stretchy (like Turkish ice cream) | |

The following ingredients were used for the lacto ice creams.
Starch composition for food products: Starch composition for food products obtained in Example 1-2 or 5
Skimmed milk powder: “Skim Milk Powder Hokkaido skimmed milk powder” manufactured by Yotsuba Milk Products Co., Ltd.
Refined coconut oil: “Refined coconut oil” manufactured by Fuji Oil Co., Ltd.
Olive oil: “AJINOMOTO Extra Virgin Olive Oil” manufactured by J-OIL MILLS
Granulated sugar: Granulated sugar manufactured by Nissin Sugar Co., Ltd.
Stabilizer (polysaccharide thickener): “GLYLOID CS-3” Manufactured by DSP Gokyo Food and Chemical Co., Ltd.
Emulsifier: “RYOTO polyglycerol ester M-7D” (HLB16) manufactured by Mitsubishi-Chemical Foods Corporation
Dextrin: Sandec #100″ manufactured by Sanwa Starch Co. Ltd.

### Ice Cream

Ice creams were prepared according to the following method using the compositions shown in Table 11, and their textures were evaluated by eight expert panelists. Results are shown in Table 11.

### <Method for Preparing Ice Cream>

1. The starch composition for food products obtained in Example 1-2 was mixed with olive oil.

2. Cow’s milk, soymilk or almond milk was warmed, and beet sugar was mixed into it.

3. The mixture obtained in 2. above was put into and mixed with the mixture obtained in 1. above.

4. The mixture obtained in 3. above was poured into an ice cream maker (the same one as the one used in [6] above) and stirred for 50 minutes to obtain ice cream.

5. The resulting ice cream was transferred to a cup and frozen in the freezer for a while.

6. The ice creams were taken out of the freezer at the same time to compare their textures.

TABLE 11

| | Example 5-1 (blended with Cow’s milk) | | Example 5-2 (blended with soymilk) | | Example 5-3 (blended with almond milk) | |
|---|---|---|---|---|---|---|
| Ingredients | Percentage (%) | Mass (g) | Percentage (%) | Mass (g) | Percentage (%) | Mass (g) |
| Olive oil | 10 | 60 | 10 | 60 | 10 | 60 |
| Cow’s milk | 60 | 360 | 0 | 0 | 0 | 0 |
| Soymilk | 0 | 0 | 60 | 360 | 0 | 0 |
| Almond milk | 0 | 0 | 0 | 0 | 60 | 360 |
| Beet sugar | 27 | 162 | 27 | 162 | 27 | 162 |
| Starch composition for food products (Example 1-2) | 3 | 18 | 3 | 18 | 3 | 18 |
| Total | 100 | 600 | 100 | 600 | 100 | 600 |
| Texture evaluation | Hard to melt; resilient; the second most pleasant meltability in mouth with rich flavor | | Hard to melt; most resilient | | Hard to melt; the most pleasant meltability in mouth with rich flavor | |

The following ingredients were used for the ice creams.
Starch composition for food products: Starch composition for food products obtained in Example 1-2
Olive oil: “AJINOMOTO Extra Virgin Olive Oil FRUTIA PREMIUM” manufactured by J-OIL MILLS
Cow’s milk: “Nasu-gyunyu” manufactured by Yaoko Co. Ltd.
Soymilk: Organic soymilk manufactured by Sujahta Meiraku
Almond milk: “Almond milk supervised by TANITA Cafe” manufactured by MARUSAN-AI Co., Ltd.
Beet sugar: Beet sugar manufactured by HOKUREN Federation of Agricultural Cooperatives

### Ice Cream

Ice creams were prepared according to the following method using the compositions shown in Table 12, and eight expert panelists evaluated the texture of the ice creams in comparison with a control case without the starch composition for food products of the present invention. Results are shown in Table 12.

### <Method for Preparing Ice Cream>

1. The starch composition for food products obtained in Example 1-2 was mixed with olive oil.

2. Cow’s milk was warmed, and beet sugar was mixed into it.

3. The mixture obtained in 2. above was put into and mixed with the mixture obtained in 1. above.

4. The mixture obtained in 3. above was poured into an ice cream maker (the same one as the one used in [6] above) and stirred for 50 minutes to obtain ice cream.

5. The resulting ice cream was transferred to a cup and frozen in the freezer for a while.

6. The ice creams were taken out of the freezer at the same time to compare their textures.

TABLE 12

| | Control case 6-1 | | Example 6-1 (Starch composition for food products: Oil = 1:2) | | Example 6-2 (Starch composition for food products: Oil = 1:4) | |
|---|---|---|---|---|---|---|
| Ingredients | Percentage (%) | Mass (g) | Percentage (%) | Mass (g) | Percentage (%) | Mass (g) |
| Olive oil | 5 | 35 | 10 | 70 | 20 | 160 |
| Cow’s milk | 70 | 490 | 60 | 420 | 50 | 400 |
| Beet sugar | 25 | 175 | 25 | 175 | 25 | 200 |
| Starch composition for food products (Example 1-2) | 0 | 0 | 5 | 35 | 5 | 40 |
| Total | 100 | 700 | 100 | 700 | 100 | 800 |
| Texture evaluation | - | | Pleasant meltability in mouth, gelato-like palatability | | Most pleasant meltability in mouth, but slightly gel-like impression | |

The following ingredients were used for the ice creams.
Starch composition for food products: Starch composition for food products obtained in Example 1-2
Olive oil: “AJINOMOTO Extra Virgin Olive Oil” manufactured by J-OIL MILLS
Cow’s milk: “Nasu-gyunyu” manufactured by Yaoko Co. Ltd.
Beet sugar: Beet sugar manufactured by HOKUREN Federation of Agricultural Cooperatives

### Ice Cream

Ice creams were prepared according to the following method using the compositions shown in Table 13, and eight expert panelists evaluated the texture of the ice creams in comparison with a control case without the starch composition for food products of the present invention. Results are shown in Table 13.

### <Method for Preparing Ice Cream>

1. The starch composition for food products obtained in Example 1-2 was mixed with olive oil.

2. Cow’s milk was warmed, and caster sugar was mixed into it.

3. The mixture obtained in 2. above was put into and mixed with the mixture obtained in 1. above.

4. The mixture obtained in 3. above was poured into an ice cream maker (the same one as the one used in [6] above) and stirred for 50 minutes to obtain ice cream.

5. The resulting ice cream was transferred to a cup and frozen in the freezer for a while.

6. The ice creams were taken out of the freezer at the same time to compare their textures.

TABLE 13

| | Control case 7-1 | | Example 7-1 | | Example 7-2 | |
|---|---|---|---|---|---|---|
| | | | (Starch composition for food products: Oil = 1:2) | | (Starch composition for food products: Oil = 1:4) | |
| Ingredients | Percentage (%) | Mass (g) | Percentage (%) | Mass (g) | Percentage (%) | Mass (g) |
| Canola oil | 6 | 210 | 6 | 210 | 12 | 420 |
| Cow’s milk | 69 | 2415 | 66 | 2310 | 60 | 2100 |
| Caster sugar | 25 | 875 | 25 | 875 | 25 | 875 |
| Starch composition for food products (Example 1-2) | 0 | 0 | 3 | 105 | 3 | 105 |
| Total | 100 | 3500 | 100 | 3500 | 100 | 3500 |
| Texture evaluation | Melts right in the mouth; Ice cream that only has pleasant meltability in mouth; Frozen dessert that gives popsicle-like impression, like milk bar | | Frozen dessert that gives an impression similar to gelato with dense texture; Pleasant meltability in mouth and yet melts slowly so that richness of the milk can be felt; Strong milkiness | | Gelato-like impression with a denser texture than that of Example 7-1; Pleasant meltability in mouth and yet melts slowly for a frozen dessert so that richness of the milk can be felt | |

The following ingredients were used for the ice creams.
Starch composition for food products: Starch composition for food products obtained in Example 1-2
Canola oil: Edible rapeseed oil “Sarasara Canola Oil” manufactured by J-OIL MILLS
Cow’s milk: “Nasu-gyunyu” manufactured by Yaoko Co. Ltd.
Caster sugar: “Cup mark caster sugar” manufactured by Nissin Sugar Co., Ltd.

### 1] Lacto Ice Cream

Lacto ice creams were prepared according to the following method using the compositions shown in Table 14A, and five expert panelists evaluated the textures of the ice creams in comparison with a control case without the ice-crystal stabilizer of the present invention. Results are shown in Table 14A.

### <Method for Preparing Lacto Ice Cream>

1. Powder (ice-crystal stabilizer, dextrin), granulated sugar, an emulsifier, and a polysaccharide thickener were taken into a bag and mixed to obtain a mixture.

2. Powdered reduced starch syrup, water, and cow’s milk were dissolved and mixed with a spoon.

3. In a water bath at 75° C., the mixture obtained in 1. above was gradually blended into the mixture obtained in 2. above while stirring at about 450-550 rpm using a stirrer (Stirrer ZZ series manufactured by Tokyo Rikakikai Co., Ltd. (EYELA)).

4. Refined coconut oil was further added to the mixture obtained in 3. above and stirred.

5. After the mixture obtained in 4. above reached 70° C., the mixture was stirred for 10 minutes.

6. Water was added to the mixture obtained in 5 above to compensate the loss of moisture that evaporated during stirring.

7. The mixture was emulsified using stirrer T.K. HOMOGENIZING DISPER (T.K. HOMO MIXER MARK II manufactured by Tokushu Kika Kogyo Co., Ltd.) at 5000-5500 rpm for 5 minutes.

8. The emulsion obtained in 7. above was cooled to 15° C. while stirring the mixture using a stirrer (Stirrer ZZ series manufactured by Tokyo Rikakikai Co., Ltd. (EYELA)) at about 350-450 rpm.

9. After reaching 15° C., the mixture was set in an ice cream maker (CUISINART COMMERCIAL QUALITY ICE CREAM & GELATO MAKER “ICE-100” manufactured by Cuisinart) to be frozen while stirring for 30 minutes to obtain a lacto ice cream.

10. The resulting lacto ice cream was transferred into a container and stored in a freezer at -20° C. for one week (good conditions), after which texture was evaluated. Thereafter, the product was transferred to a -10° C. freezer and textures were evaluated after 2 weeks and 1 month (poor conditions).

TABLE 14A

| | | Control case 8-1 | | Example 8-1 | | Example 8-2 | |
|---|---|---|---|---|---|---|---|
| Ingredients | | Percentage (%) | Mass (g) | Percentage (%) | Mass (g) | Percentage (%) | Mass (g) |
| Cow’s milk | | 65 | 650 | 65 | 650 | 65 | 520 |
| Refined coconut oil | | 12 | 120 | 12 | 120 | 12 | 96 |
| Granulated sugar | | 9.5 | 95 | 9.5 | 95 | 9.5 | 76 |
| Powdered reduced starch syrup | | 6.1 | 60.5 | 6.1 | 60.5 | 5.6 | 44.4 |
| Dextrin | | 1 | 10 | 1 | 10 | 0 | 0 |
| Ice-crystal stabilizer (Example 1-2) | | 0 | 0 | 0.3 | 2.5 | 2 | 16 |
| Emulsifier | | 0.3 | 2.5 | 0 | 0 | 0 | 0 |
| Polysaccharide thickener | | 0.3 | 2.5 | 0.3 | 2.5 | 0 | 0 |
| Water | | 6 | 59.5 | 6 | 59.5 | 6 | 47.6 |
| Total | | 100 | 1000 | 100 | 1000 | 100 | 800 |
| Texture evaluation | (Good conditions) After 1 week of storage at -20° C. | Smooth texture | | Smooth texture | | Smooth texture | |
| | (Poor conditions) After 2 weeks of storage at -10° C. | Many large ice crystals were observed, frosty texture | | Large ice crystals were fewer, and frosty texture was weaker than Control case 8-1 Smooth texture | | Large ice crystals were scarcely observed, and frosty texture was weaker than Control case 8-1 Smooth texture | |
| | (Poor conditions) After 1 month of storage at -10° C. | Many large ice crystals were observed, notably coarse texture Grainy texture | | Large ice crystals were fewer, and coarse texture was weaker than Control case 8-1 Smoother texture than Control case 8-1 | | Large ice crystals were scarcely observed, and almost no coarseness was felt compared to Control case 8-1 Much smooth texture than Control case 8-1 | |

The following ingredients were used for the lacto ice creams.
Ice-crystal stabilizer: Starch composition for food products obtained in Example 1-2
Cow’s milk: “Bokujo-umare-no-gyunyu” manufactured by Gunma prefecture milk producers’ cooperative union
Refined coconut oil: “Refined coconut oil” manufactured by Fuji Oil Co., Ltd.
Granulated sugar: Granulated sugar manufactured by Nissin Sugar Co., Ltd.
Powdered reduced starch syrup: “Sweet P EM” manufactured by B Food Science Co., Ltd.
Dextrin: “Sandec #100” manufactured by Sanwa Starch Co. Ltd.
Emulsifier: Distilled monoglyceride (hydrogenated palm oil) “Myverol 18-04K” manufactured by KERRY
Polysaccharide thickener: “GLYLOID CS-3” manufactured by DSP Gokyo Food and Chemical Co., Ltd.

### 2] Lacto Ice Cream

Lacto ice creams were prepared according to the method described in [10-1] above using the compositions shown in Table 14B, and evaluated for how melting progressed in an atmosphere at 25° C. in comparison with a control case without the ice-crystal stabilizer of the present invention. Results are shown in Table 14B.

### <Method for Evaluating How Melting Progresses>

80 g of the prepared lacto ice cream was removed from the freezer and left at room temperature (25° C.). After 30, 50, 60, and 70 minutes, the melted liquid content was removed and the mass of the remaining solid content was measured. The percentages of the remaining solid contents are shown in Table 14B.

TABLE 14B

| | | Control case 8-1 | | Example 8-3 | |
|---|---|---|---|---|---|
| Ingredients | | Percentage (%) | Mass (g) | Percentage (%) | Mass (g) |
| Cow’s milk | | 65 | 650 | 65 | 650 |
| Refined coconut oil | | 12 | 120 | 12 | 120 |
| Granulated sugar | | 9.5 | 95 | 9.5 | 95 |
| Powdered reduced starch syrup | | 6.1 | 60.5 | 4.6 | 45.5 |
| Dextrin | | 1 | 10 | 0 | 0 |
| Ice-crystal stabilizer (Example 1-2) | | 0 | 0 | 3 | 30 |
| Emulsifier | | 0.3 | 2.5 | 0 | 0 |
| Polysaccharide thickener | | 0.3 | 2.5 | 0 | 0 |
| Water | | 6 | 59.5 | 5.95 | 59.5 |
| Total | | 100 | 1000 | 100 | 1000 |
| Remaining solid content [Mass %] | After 30 minutes | 54% | | 92% | |
| | After 50 minutes | 36% | | 65% | |
| | After 60 minutes | 23% | | 46% | |
| | After 70 minutes | 9% | | 26% | |

### Lacto Ice Cream

Lacto ice creams were prepared according to the following method using the compositions shown in Table 15. 80 g of each lacto ice cream was weighed into a plastic cup and left at room temperature (25° C.). The remaining solid contents after 30, 50, 60, 70, and 80 minutes were measured. The percentage of the remaining solids (%) was determined by dividing the remaining solid content (g) at each time point by 80 (g) x 100 (remaining solids (%) = remaining solid content (g) at each time point / 80 (g) x 100). Results are shown in Table 15.

### <Method for Preparing Lacto Ice Cream>

1. Powder (ice-crystal stabilizer, dextrin), granulated sugar, an emulsifier, and a polysaccharide thickener were taken into a bag and mixed to obtain a mixture.

2. Powdered reduced starch syrup, water, and cow’s milk were dissolved and mixed with a spoon.

3. In a water bath at 75° C., the mixture obtained in 1. above was gradually blended into the mixture obtained in 2. above while stirring at about 450-550 rpm using a stirrer (Stirrer ZZ series manufactured by Tokyo Rikakikai Co., Ltd. (EYELA)).

4. Refined coconut oil was further added to the mixture obtained in 3. above and stirred to give a mixture.

5. After the mixture obtained in 4. above reached 70° C., the mixture was stirred for 10 minutes.

6. Water was added to the mixture obtained in 5 above to compensate the loss of moisture that evaporated during stirring.

7. The mixture was emulsified using stirrer T.K. HOMOGENIZING DISPER (T.K. HOMO MIXER MARK II manufactured by Tokushu Kika Kogyo Co., Ltd.) at 5000-5500 rpm for 5 minutes.

8. The emulsion obtained in 7. above was cooled to 15° C. while stirring the mixture using a stirrer (Stirrer ZZ series manufactured by Tokyo Rikakikai Co., Ltd. (EYELA)) at about 350-450 rpm.

9. After reaching 15° C., the mixture was set in an ice cream maker (CUISINART COMMERCIAL QUALITY ICE CREAM & GELATO MAKER “ICE-100” manufactured by Cuisinart) to be frozen while stirring for 30 minutes to obtain a lacto ice cream.

10. The resulting lacto ice cream was transferred into a container and frozen in the freezer for about a week.

TABLE 15

| | Control case 9 | | Example 9 | | Comparative example 9-1 | | Comparative example 9-2 | | Comparative example 9-3 | |
|---|---|---|---|---|---|---|---|---|---|---|
| Ingredients | Percentage (%) | Mass (g) | Percentage (%) | Mass (g) | Percentage (%) | Mass (g) | Percentage (%) | Mass (g) | Percentage (%) | Mass (g) |
| Cow’s milk | 65 | 390 | 65 | 325 | 65 | 325 | 65 | 325 | 65 | 325 |
| Refined coconut oil | 12 | 72 | 12 | 60 | 12 | 60 | 12 | 60 | 12 | 60 |
| Granulated sugar | 9.5 | 57 | 9.5 | 47.5 | 9.5 | 47.5 | 9.5 | 47.5 | 9.5 | 47.5 |
| Powdered reduced starch syrup | 6.05 | 36.3 | 4.55 | 22.75 | 4.55 | 22.75 | 4.55 | 22.75 | 4.55 | 22.75 |
| Dextrin | 1 | 6 | 0 | 0 | 0 | 0 | 0 | 0 | 0 | 0 |
| Ice-crystal stabilizer (Example 1-2) | 0 | 0 | 3 | 15 | 0 | 0 | 0 | 0 | 0 | 0 |
| Starch composition for food products (Comparative example 1) | 0 | 0 | 0 | 0 | 3 | 15 | 0 | 0 | 0 | 0 |
| Starch composition for food products (Comparative example 2) | 0 | 0 | 0 | 0 | 0 | 0 | 3 | 15 | 0 | 0 |
| Starch composition for food products (Comparative example 3) | 0 | 0 | 0 | 0 | 0 | 0 | 0 | 0 | 3 | 15 |
| Emulsifier | 0.25 | 1.5 | 0 | 0 | 0 | 0 | 0 | 0 | 0 | 0 |
| Polysaccharide thickener | 0.25 | 1.5 | 0 | 0 | 0 | 0 | 0 | 0 | 0 | 0 |
| Water | 5.95 | 35.7 | 5.95 | 29.75 | 5.95 | 29.75 | 5.95 | 29.75 | 5.95 | 29.75 |
| Total | 100 | 600 | 100 | 500 | 100 | 500 | 100 | 500 | 100 | 500 |
| Percentage of remaining solid after 30 minutes | 54.0% | | 91.6% | | 71.2% | | 67.0% | | 62.8% | |
| Percentage of remaining solid after 50 minutes | 36.3% | | 65.3% | | 43.3% | | 38.9% | | 38.2% | |
| Percentage of remaining solid after 60 minutes | 22.6% | | 46.2% | | 24.8% | | 27.8% | | 23.9% | |
| Percentage of remaining solid after 70 minutes | 9.1% | | 26.3% | | 14.9% | | 12.2% | | 10.8% | |
| Percentage of remaining solid after 80 minutes | 0% | | 8.7% | | 0% | | 0% | | 0% | |

The following ingredients were used for the lacto ice creams.
Ice-crystal stabilizer: Starch composition for food products obtained in Example 1-2
Starch compositions for food products: Starch compositions for food products obtained in Comparative examples 1, 2, and 3
Cow’ s milk: “Bokujo-umare-no-gyunyu” manufactured by Gunma prefecture milk producers’ cooperative union
Refined coconut oil: “Refined coconut oil” manufactured by Fuji Oil Co., Ltd.
Granulated sugar: Granulated sugar manufactured by Nissin Sugar Co., Ltd.
Powdered reduced starch syrup: “Sweet P EM” manufactured by B Food Science Co., Ltd.
Dextrin: “Sandec #100” manufactured by Sanwa Starch Co. Ltd.
Emulsifier: Distilled monoglyceride (hydrogenated palm oil) “Myverol 18-04K” manufactured by KERRY
Polysaccharide thickener: “GLYLOID CS-3” Manufactured by DSP Gokyo Food and Chemical Co., Ltd.

As shown in Table 15, the lacto ice cream of Example 9, to which the ice-crystal stabilizer of the present invention was added, had extremely good shape retention property compared to Control case 9, to which an emulsifier and a polysaccharide thickener, i.e., commonly used stabilizers, were added. Moreover, the lacto ice cream of Example 9 had a thick, rich texture and had excellent meltability in mouth.

The lacto ice cream of Example 9 had superior shape retention property compared to the starch compositions for food products of Comparative examples 1 to 3.

The lacto ice creams of Comparative examples 9-1 to 9-3 had better shape retention property than the lacto ice cream of Control case 9, but they had unpleasant grainy mouthfeel, were very powdery, and had unpleasant meltability in mouth.

### Wasabi (Japanese Horseradish) Paste

Wasabi pastes were prepared according to the following method using the mixing ratios of raw ingredients shown in Table 16, and their textures were evaluated by two expert panelists. For texture evaluation, wasabi paste without the starch composition for food products was prepared as Control case 10, and the difference in texture from Control example 10 was evaluated. Results are shown in Table 16.

### <Method for Preparing Wasabi Paste>

1. Wasabi pastes were prepared by mixing powdered wasabi with water at a mass ratio of 25:75, into which the starch composition for food products was blended to give the compositions shown in Table 16.

2. Wasabi pastes were put into plastic cups with lids and stored at 4° C. (under refrigerated or other conditions).

3. The texture and taste of the wasabi pastes were evaluated after 2 days of storage.

The following ingredients were used for the wasabi pastes.
Starch composition for food products: Starch composition for food products obtained in Example 1-2
Powdered wasabi: Powdered wasabi manufactured by House Foods Corporation

TABLE 16

| | | | |
|---|---|---|---|
| | Control case 10 | Example 10-1 | Example 10-2 |
| Mixing ratio of raw ingredients | Powdered wasabi: Water = 25:75 | Starch composition for food products: Powdered wasabi: Water = 1:25:75 | Starch composition for food products: Powdered wasabi: Water = 3:25:75 |
| Results of workability evaluation | - | Starch composition for food products dispersed in unheated state | Starch composition for food products dispersed in unheated state |
| Results of texture and taste evaluations | The texture was watery right in the mouth and powdery after eating. The taste was watery and the wasabi flavor was weak. | The texture was smooth, fine and thick, like finely grated horseradish. Strong pungent taste. | The texture was extremely thick, smooth, and fine. Strong pungent taste. |

### Smoothie

Smoothies were prepared according to the following method using the mixing ratios of raw ingredients shown in Table 17, and their textures were evaluated by three expert panelists. For texture evaluation, a smoothie without the starch composition for food products was prepared as Control case 11 to evaluate the difference in texture from Control case 11. Results are shown in Table 17.

### <Method for Preparing Smoothie>

1. The starch composition for food products, granulated sugar, flavoring, and soymilk were mixed at a weight ratio of 0-4:5:2:90-93, and then the mixture was homogenized in a food processor (“BAMIX M300” manufactured by ESGE AG, Switzerland) to give a smoothie. Granulated sugar and the starch composition for food products were mixed in advance.

2. The texture was evaluated immediately after preparation.

The following ingredients were used for the smoothies.
Starch composition for food products: Starch composition for food products obtained in Example 1-2
Flavoring: “FLORENTINES Flavor-Enhanced Banana Juice ½X” manufactured by Yokoyama Koryo Limited
Soymilk: “SOYMILK UNSWEETENED Organic Certified” manufactured by MARUSAN-AI Co., Ltd.
Pregelatinized starch: Pregelatinized product of distarch phosphate potato starch “BAKEUP B-α” manufactured by J-OIL MILLS

TABLE 17

| | | | |
|---|---|---|---|
| | Control case 11 | Example 11 | Comparative example 11 |
| Mixing ratio of raw ingredients | Granulated sugar: Flavoring: Soymilk = 5:2:93 | Starch composition for food products: Granulated sugar: Flavoring: Soymilk = 3:5:2:93 | Pregelatinized starch: Granulated sugar: Flavoring: Soymilk = 3:5:2:93 |
| Results of workability evaluation | - | Dispersed in unheated state | Tiny lumps were formed |
| Results of texture and taste evaluations | Texture was silky. Tasted like a thin smoothie. | The texture was thick, as if the fruit had been mixed in a blender. Viscous but silky so that it is easy to drink. Taste was strongly reminiscent of banana and soymilk flavor, even after swallowing. | The texture was heavy and highly viscous, with tiny lumps. The lumpy portions were somewhat rough upon eating. Flavor was also somewhat muffled. |

### Soup (Shrimp Bisque Style)

Soups were prepared according to the following method and their textures were evaluated by three expert panelists. For texture evaluation, soup added with rice flour and soup added with a modified starch were prepared as Control cases 12-1 and 12-2, respectively, to evaluate the difference in texture from these controls. Results are shown in Table 18.

### <Method for Preparing Soup>

1. Any one of the starch composition for food products (0.7% by mass), a modified starch (0.3% by mass), and rice flour (0.5% by mass) were mixed with a commercial soup stock (22.9 g), to which 150 g of hot water was added and mixed.

2. The resulting soup was put into a water-resistant storage container and stored in a refrigerator.

3. After 3 days of refrigerated storage, textures (thick texture, mouthfeel, etc.) of the soups were evaluated in a warm state after microwave heating.

The following ingredients were used for the soups.
Starch composition for food products: Starch composition for food products obtained in Example 1-2
Commercially available soup stock: “Knorr Cup Soup Premium Shrimp Bisque” manufactured by Ajinomoto Co., Inc.
Modified starch: Hydroxypropyl distarch phosphate wheat starch “JELCALL WPO-10” manufactured by J-OIL MILLS

TABLE 18

| | | | |
|---|---|---|---|
| | Control case 12-1 | Control case 12-2 | Example 12 |
| Type of starch added | Rice flour | Modified starch | Starch composition for food products |
| Results of texture evaluation | Pleasant meltability in mouth but thick texture was absent. | Moderately viscous and pleasant meltability in mouth but thick texture was absent. | Good mouthfeel when put in the oral cavity and a thick texture was perceived. Meltability in mouth was extremely pleasant. |

### Dairy Beverage

Dairy beverages were prepared according to the following method using the mixing ratios of raw ingredients shown in Table 19, and their textures were evaluated by three expert panelists. As Comparative example 13, a dairy beverage added with a pregelatinized starch was prepared. The evaluation results are shown in Table 19.

### <Method for Preparing Dairy Beverage>

1. Rapeseed oil (3 g) was mixed with the starch composition for food products (3 g) or a pregelatinized starch (3 g) to give a paste.

2. Low-fat cow’s milk (150 g) was poured and mixed using a food processor (“BAMIX M300” manufactured by ESGE AG, Switzerland).

3. After 3 hours of refrigerated storage, the texture (thick texture and mouthfeel) of the resulting dairy beverage was evaluated.

The following ingredients were used for the dairy beverages.
Starch composition for food products: Starch composition for food products obtained in Example 1-2
Low-fat cow’s milk: “Morinaga Oishii-Gyunyu Low-Fat Milk” manufactured by Morinaga Milk Industry Co., Ltd.
Pregelatinized starch: Pregelatinized product of distarch phosphate potato starch “BAKEUP B-α” manufactured by J-OIL MILLS

TABLE 19

| | | | |
|---|---|---|---|
| | Control case 13 | Example 13 | Comparative example 13 |
| Mixing ratio of raw ingredients | Low-fat cow’s milk: Rapeseed oil = 150:3 | Low-fat cow’s milk: Rapeseed oil: Starch composition for food products = 150:3:3 | Low-fat cow’s milk: Rapeseed oil: Pregelatinized starch = 150:3:3 |
| Results of workability evaluation | Separation of oils/fats was observed. | Oils/fats were homogenously dispersed with favorably less bubbling. | Bubbling was significant and workability was poor. |
| Results of texture evaluations | Thick texture was absent. | The flavor remained in the oral cavity after swallowing and a thick texture was perceived. | Although viscosity could be felt upon eating, the flavor did not remain in the oral cavity after swallowing, and a thick texture was absent. |

### Yogurt

Yogurts were prepared according to the following method using the mixing ratios of raw ingredients shown in Table 20, and their textures were evaluated by three expert panelists. As Comparative example 14, a yogurt added with a pregelatinized starch was prepared. The evaluation results are shown in Table 20.

### <Method for Preparing Yogurt>

1. Granulated sugar (15 g) was mixed with the starch composition for food products (3 g) or a pregelatinized starch (3 g).

2. Low-fat yogurt (150 g) was added and mixed using a food processor (“BAMIX M300” manufactured by ESGE AG, Switzerland).

3. After 3 hours of refrigerated storage, textures (thick texture, mouthfeel, etc.) of the resulting yogurts were evaluated.

The following ingredients were used for the yogurts.
Starch composition for food products: Starch composition for food products obtained in Example 1-2
Low-fat yogurt: “Bifidus Plain Yogurt with Zero Fat” manufactured by Morinaga Milk Industry Co., Ltd.
Pregelatinized starch: Pregelatinized product of distarch phosphate potato starch “BAKEUP B-α” manufactured by J-OIL MILLS

TABLE 20

| | | | |
|---|---|---|---|
| | Control case 14 | Example 14 | Comparative example 14 |
| Mixing ratio of raw ingredients | Low-fat yogurt: Granulated sugar = 150:15 | Low-fat yogurt: Granulated sugar: Starch composition for food products = 150:15:3 | Low-fat yogurt: Granulated sugar: Pregelatinized starch = 150:15:3 |
| Results of texture evaluations | Thick texture was absent. | Moderate viscosity could be felt upon eating, the flavor remained in the oral cavity even after swallowing, and a thick | Although viscosity could be felt upon eating, the flavor did not remain in the oral cavity after swallowing, and a thick |
| | | texture was perceived. | texture was absent. |

### Vegetable Yogurt

Vegetable yogurts were prepared according to the following method using the mixing ratios of raw ingredients shown in Tables 21 and 22, and their textures were evaluated by three expert panelists. As Comparative examples 15-1 and 15-2, vegetable yogurts added with a pregelatinized starch were prepared. The evaluation results obtained are shown in Tables 21 and 22.

### <Method for Preparing Vegetable Yogurt>

1. Granulated sugar (15 g) was mixed with the starch composition for food products (3 g) or a pregelatinized starch (3 g).

2. Vegetable yogurt (150 g) was added and mixed using a food processor (“BAMIX M300” manufactured by ESGE AG, Switzerland).

3. After 3 hours of refrigerated storage, textures (thick texture, mouthfeel, etc.) of the resulting vegetable yogurts were evaluated.

[ 0178] The following ingredients were used for the vegetable yogurts.
Starch composition for food products: Starch composition for food products obtained in Example 1-2
Vegetable yogurt A: “Soybean Yogurt” manufactured by Fujicco
Vegetable yogurt B: “Soy yogurt” manufactured by MARUSAN-AI Co., Ltd.
Pregelatinized starch A: “JELCALL GT-α” (pregelatinized product of acetylated distarch phosphate tapioca starch) manufactured by J-OIL MILLS
Pregelatinized starch B: “BAKEUP B-α” (pregelatinized product of distarch phosphate potato starch) manufactured by J-OIL MILLS

TABLE 21

Vegetable yogurt A

| | | | |
|---|---|---|---|
| | Control case 15-1 | Example 15-1 | Comparative example 15-1 |
| Mixing ratio of raw ingredients | Vegetable yogurt A: Granulated sugar = 150:15 | Vegetable yogurt A: Granulated sugar: Starch composition for food products = 150:15:3 | Vegetable yogurt A: Granulated sugar: Pregelatinized starch A = 150:15:3 |
| Results of texture evaluations | Thick texture was absent. | Moderate viscosity could be felt upon eating, the flavor remained in the oral cavity after swallowing, and a thick texture was perceived. The sour taste and soy flavor were mild compared to the control case. | Although viscosity could be felt upon eating, the flavor did not remain in the oral cavity after swallowing, and a thick texture was absent. Flavor was comparable to the control case. |

TABLE 22

Vegetable yogurt B

| | | | |
|---|---|---|---|
| | Control case 15-2 | Example 15-2 | Comparative example 15-2 |
| Mixing ratio of raw ingredients | Vegetable yogurt B: Granulated sugar = 150:15 | Vegetable yogurt B: Granulated sugar: Starch composition for food products = 150:15:3 | Vegetable yogurt B: Granulated sugar: Pregelatinized starch = 150:15:3 |
| Results of texture evaluations | Thick texture was absent. | Moderate viscosity could be felt upon eating, the flavor remained in the oral cavity after swallowing, and a thick texture was perceived. The sour taste and soy flavor were mild compared to the control case. | Although viscosity could be felt upon eating, the flavor did not remain in the oral cavity after swallowing, and a thick texture was absent. Flavor was comparable to the control case. |

### Soup (Corn Soup)

Corn soups were prepared according to the following method using the mixing ratios of raw ingredients shown in Table 23, and their textures were evaluated by four expert panelists. A corn soup added with a pregelatinized starch and a corn soup added with hydroxypropyl distarch phosphate wheat starch were prepared as Comparative examples 16-1 and 16-2, respectively. Results of evaluation are shown in Table 23.

### <Method for Preparing Corn Pottage>

1. 29 g of water, 30 g of cow’s milk, 40 g of frozen corn puree, 0.5 g of chicken bouillon, 0.3 g of caster sugar, and 0.2 g of salt were weighed into a saucepan and stirred while heating without boiling to obtain a corn soup of Control case 16.

2. The corn soup prepared in the same formula as 1. above was mixed with the starch composition for food products, a pregelatinized starch or a hydroxypropyl distarch phosphate wheat starch in the amount shown in Table 23, thereby obtaining corn soups.

3. The texture and taste of the corn soups obtained were evaluated.

The following ingredients were used for the corn soups.
Starch composition for food products: Starch composition for food products obtained in Example 1-2
Cow’s milk: “Oishii-Gyunyu” manufactured by Meiji Co., Ltd.
Frozen corn puree: Corn puree manufactured by KAGOME Co., Ltd.
Chicken bouillon: “Knorr Special Chicken Bouillon” manufactured by Ajinomoto Co., Inc.
Caster sugar: Caster sugar manufactured by Mitsui DM Sugar Co., Ltd.
Salt: Salt manufactured by The Salt Industry Center of Japan
Pregelatinized starch: “BAKEUP B-α” (pregelatinized product of distarch phosphate potato starch) manufactured by J-OIL MILLS
Hydroxypropyl distarch phosphate wheat starch “JELCALL WPO-10” manufactured by J-OIL MILLS

TABLE 23

| | | | | | |
|---|---|---|---|---|---|
| | Control case 16 | Comparative example 16-1 | Comparative example 16-2 | Example 16-1 | Example 16-2 |
| Starch composition for food products | | | | 1.5 g | 3 g |
| Pregelatinized starch | | 3 g | | | |
| Hydroxypropyl distarch phosphate wheat starch | | | 3 g | | |
| Results of texture evaluations | Silky, and thick texture was absent | Chewy, heavy, and highly viscous, making it difficult to drink. Lumps were felt. | Viscous but a thick texture was absent. Unpleasant feeling going down the throat. Gel-like lumps were felt. | Creamy and fluffy as if it had been aerated with a mixer and had thick like a potage. Fiber texture, texture of ingredient, and puree-like texture like coarsely-sieved corn were felt. | Very creamy and fluffy as if it had been aerated with a mixer and had thick like a potage. Fiber texture, texture of ingredient, and puree-like texture like coarsely-sieved corn were felt. |
| Results of taste evaluations | Tasted somewhat like a watery cup of soup. | Taste was hardly noticeable. | The taste was more intense than the control. Tasted mild. | Delicious, with a sense of oil/fat as if it contained fresh cream. Milk and corn tasted strong. | Delicious, with a sense of oil/fat as if it contained fresh cream. Milk and corn tasted strong. |

The particle size fractions of the starch compositions for food products used in Examples 10 to 16 were as follows.
Remained on the sieve with an aperture size of 0.25 mm: 1.7% by mass
Remained on the sieve with an aperture size of 0.075 mm but passed through the sieve with an aperture size of 0.25 mm: 82.1% by mass
Passed through the sieve with an aperture size of 0.075 mm: 16.2% by mass

### Lacto Ice Cream

An ice cream mix solution was prepared according to the following method using the composition shown in Table 24, and ice crystals were evaluated in comparison with a control case that did not contain the ice-crystal stabilizer of the present invention. Results are shown in FIG. 4.

### <Method for Preparing Ice Cream Mix Solution>

1. Skimmed milk powder, granulated sugar, and the ice-crystal stabilizer were mixed.

2. Cow’s milk, Nice-Whip E, frozen egg yolk, and water were added to the mixture of 1. and stirred.

3. The mixture of 2. was emulsified using a homo mixer (“T.K. Homo Mixer MARKII” manufactured by Tokushu Kika Kogyo Co., Ltd.) at 12,000 rpm for 10 minutes.

4. The mixture obtained in 3. was sealed in a retort pouch (500 mL).

5. The resultant was subjected to retort processing at 85° C. for 15 minutes.

6. The mixture of 5. was again stirred using a homo mixer at 12,000 rpm for 10 minutes, cooled, and then vanilla extract was added.

7. The product was sealed again in a retort pouch and placed in a refrigerator at 5-7° C. for 24 hours to obtain the ice cream mix solution.

### <Method for Evaluating Ice Crystal Growth>

2 µL of ice cream mix solution and a SUS shim ring spacer were placed between two cover glasses with a thickness of 0.012-0.017 mm and a diameter of 16 mm. The resultant was placed on a microscope cooling stage (“HF95” manufactured by Linkam Scientific Instruments). The temperature history of the stage was as follows: the temperature was cooled down to -60° C. at -90° C./min, then increased to -8° C. at +5° C./min without a holding time, and held for 90 minutes to observe the crystal growth. A digital microscope (“VHX-900” manufactured by KEYENCE) was used for the observation.

TABLE 24

| Mass% | Reference example 17 | Example 17 |
|---|---|---|
| Cow’s milk | 60 | 58.8 |
| Nice-Whip E | 2 | 2 |
| Skimmed milk powder | 10 | 9.8 |
| Granulated sugar | 12 | 11.8 |
| Frozen egg yolk | 5 | 4.9 |
| Vanilla extract | 0.1 | 0.1 |
| Ice-crystal stabilizer | | 2 |
| Water | 10.9 | 10.6 |
| Total | 100 | 100 |

The following ingredients were used for the lacto ice creams.
Cow’s milk: “Bokujo-umare-no-gyunyu” manufactured by Gunma prefecture milk producers’ cooperative union
Nice-Whip E: Emulsified oil/fat manufactured by Nakazawa Dairy Products Co., Ltd.
Skimmed milk powder: “Skim Milk Powder Hokkaido skimmed milk powder” manufactured by Yotsuba Milk Products Co., Ltd.
Granulated sugar: Granulated sugar manufactured by Nissin Sugar Co., Ltd.
Frozen egg yolk: Frozen sweetened egg yolk 20 manufactured by Kewpie Corporation
Vanilla extract: Vanilla Essence NB No.5 manufactured by Narizuka Corporation
Ice-crystal stabilizer: Starch composition for food products obtained in Example 1-2

FIG. 8 shows microscopic images of ice crystals from (a) Reference example 17 and (b) Example 17.

As shown in FIG. 8, the size of the ice crystals of the lacto ice cream added with the starch composition for food products of the present invention as an ice-crystal stabilizer (Example 17) was smaller than that of the ice crystals in Reference Example 17. These results indicate that the ice-crystal stabilizer of the present invention can inhibit the growth of ice crystals in the lacto ice cream.

1-5. (canceled)

6. A starch composition for food products obtained by subjecting a polyglycerol fatty acid ester and one or more selected from the group consisting of raw potato starch and modified starches of said raw potato starch to a heat treatment under a pressure condition of 0 MPa or higher but lower than 100 MPa, wherein the starch composition comprises a starch-lipid complex.

7. The starch composition for food products according to claim 6, wherein the mass ratio of the polyglycerol fatty acid ester to 100 parts by mass of the one or more raw material starches selected from the group consisting of raw potato starch and modified starches of said raw potato starch is not less than 0.01 and not more than 4.8 parts by mass.

8. The starch composition for food products according to claim 6, wherein the modified starch of raw potato starch is a modified starch obtained by subjecting the raw potato starch to one or more modification treatments selected from the group consisting of cross-linking, hydroxypropylation, and esterification.

9. The starch composition for food products according to claim 6, wherein the polyglycerol fatty acid ester has a HLB value of not lower than 1 and not higher than 13 and an average degree of polymerization of not less than 2 and not more than 9.

10. The starch composition for food products according to claim 6, wherein the Brookfield viscosity (Pa·s) of a slurry, which is obtained by mixing the starch composition for food products with an edible rapeseed oil that is twice as much and water that is 7 times as much as the mass of the starch composition for food products in this order at 20° C. without heating, measured under the conditions of 30 rpm for 30 seconds is not lower than 2 Pa·s and not higher than 100 Pa·s, and
wherein the Brookfield viscosity (Pa·s) of the slurry measured under the conditions of 30 rpm for 30 seconds after cooling or heating the slurry satisfies the following condition:
“the Brookfield viscosity (Pa·s) at 0° C. is not less than twice and not more than 30 times the Brookfield viscosity at 90° C.”.

11. The starch composition for food products according to claim 10, wherein the Brookfield viscosity of the slurry at 0° C. is not lower than 5 Pa·s and not higher than 300 Pa·s.

12. The starch composition for food products according to claim 10, wherein the difference between the Brookfield viscosities (Pa·s) of the slurry at the temperatures of 20° C., 30° C., 40° C., 50° C. and 60° C. when a freeze-thaw cycle is repeated three times under the following conditions and the Brookfield viscosities (Pa·s) at the corresponding temperatures before the freeze-thaw cycle is within 10.0 Pa·s:
“<Conditions for freeze-thaw cycles>
for the first cycle, the slurry prepared at room temperature is cooled to -10° C. at a cooling rate of -1° C./min and kept in that state for at least 15 hours, then the slurry is heated to reach 60° C. at a heating rate of 45° C./min, and then cooled again to -10° C. at a cooling rate of -1° C./min and kept in that state for at least 15 hours; and
for the second cycle and on, the slurry that went through the first cycle is heated to reach 60° C. at a heating rate of 45° C./min and then cooled again to -10° C. at a cooling rate of -1° C./min and kept in that state for at least 15 hours”.

13. A method for producing a starch composition for food products, the method comprising a step of subjecting an ingredient mixture containing a polyglycerol fatty acid ester and one or more selected from the group consisting of raw potato starch and modified starches of said raw potato starch to a heat treatment under a pressure condition of 0 MPa or higher but lower than 100 MPa.

14. The method for producing a starch composition for food products according to claim 13, wherein the mass ratio of the polyglycerol fatty acid ester to 100 parts by mass of the one or more raw material starches selected from the group consisting of raw potato starch and modified starches of said raw potato starch is not less than 0.01 and not more than 4.8 parts by mass.

15. The method for producing a starch composition for food products according to claim 13, wherein the modified starch of raw potato starch is a modified starch obtained by subjecting the raw potato starch to one or more modification treatments selected from the group consisting of cross-linking, hydroxypropylation, and esterification.

16. The method for producing a starch composition for food products according to claim 13, wherein the polyglycerol fatty acid ester has a HLB value of not lower than 1 and not higher than 13 and an average degree of polymerization of not less than 2 and not more than 9.

17. The method for producing a starch composition for food products according to claim 13, wherein the step of heat treatment comprises performing a heat treatment by pressurizing and extruding the ingredient mixture using an extruder.

18. An emulsified composition comprising the starch composition for food products according to claim 6, an edible oil/fat that is not less than 0.5 times and not more than 10 times the mass of the starch composition for food products, and water that is not less than 0.5 times and not more than 10 times the mass of the starch composition for food products.

19. A food product comprising the starch composition for food products according to claim 6 .

20. The food product according to claim 19, wherein the food product is a frozen dessert.

21. (canceled)

22. (canceled)

23. (canceled)
